(19) United States
(12) Patent Application Publication
(10) Pub. No.: US 2026/0250149 A1
(43) Pub. Date: Aug. 27, 2026

(54) MIXED FERRITE NANOPARTICLES AND USES THEREOF

(71) Applicant: INSTITUT NATIONAL DE LA RECHERCHE SCIENTIFIQUE, QUEBEC (CA)

(72) Inventors: Nadi BRAIDY, SHERBROOKE (CA); Nicolas DUMARESQ, SAINT-LOUIS-DE-GONZAGUE (CA); Ana Berta LOPES CORREIA TAVARES, VERDUN (CA); Jiyun CHEN, LONGUEUIL (CA)

(21) Appl. No.: 18/995,470

(22) PCT Filed: Aug. 4, 2023
(86) PCT No.: PCT/CA2023/051045

§ 371 Date: Jan. 16, 2025

Related U.S. Application Data
(60) Provisional application No. 63/370,865, filed on Aug. 9, 2022.

(51) Int. Cl. C01G 49/06; C01G 45/1207; C01G 49/08; C01G 51/40; C01G 53/40; C25B 11/042; H01M 4/02

(52) U.S. Cl. CPC C01G 49/06; C01G 45/1207; C01G 49/08; C01G 51/40; C01G 53/40; C25B 11/042; H01M 4/02; C01P 2002/32; C01P 2004/41; C01P 2004/64; C01P 2006/12; C01P 2006/90; H01M 2004/021

(57) ABSTRACT

There are provided nanoparticles useful as Oxygen Evolution Reaction (OER) catalysts. These are nanoparticles of a ferrite of formula MnₓCo_{y}Ni₂Fe_{3-(x+y+z)}O₄, wherein each of x, y and z is ≥0 and ≤1, and wherein 0<(x+y+z)<1.5, wherein the ferrite has a spinel crystalline structure, wherein the nanoparticles have a truncated octahedron shape exposing facets, wherein said facets comprise 6 square facets and 8 hexagonal facets, wherein the square facets correspond to the {100} crystal plane and the hexagonal facets correspond to the {111} crystal plane, and wherein the nanoparticles are up to about 500 nm in size. We also provide a catalyst comprising these and the use of these nanoparticles as a catalyst. Are further provided a composition for an electrode and an electrode comprising these nanoparticles. Finally, there is provided an electrolytic cell comprising an electrode comprising the nanoparticles.

### CROSS REFERENCE TO RELATED APPLICATIONS

This application claims benefit, under 35 U.S.C. § 119 (e), of U.S. provisional application Ser. No. 63/370,865, filed on Aug. 9, 2022. All documents above are incorporated herein in their entirety by reference.

### FIELD OF THE INVENTION

The present invention relates to mixed ferrite nanoparticles of a ferrite of formula MnₓCo_{y}Ni_{z}Fe_{3-(x+y+z)}O₄, with specific crystalline structure, shape, and size. Also, the present invention is concerned with uses of these nanoparticles in electrodes for various applications.

### BACKGROUND OF THE INVENTION

The oxygen evolution reaction (OER) is one of the core electrocatalytic processes of energy conversion devices such as reversible fuel cells, metal-air batteries and electrolysers [1] Efficient catalysts are needed to enhance the reaction rate and to reduce the overpotentials at the electrodes. Precious metal oxides (RuO₂ and IrO₂) remain the default OER catalysts. However, the high cost, the scarcity of precious metals, and the high catalyst loadings required to achieve efficient performance hinder the full deployment of these technologies [2,3]. Moreover, these oxides are converted to soluble RuO₄ and IrO₃ species under high anodic potentials [4-6]. Thus, precious metals must be minimized or even replaced using robust non-precious catalysts with high electrocatalytic activity.

Numerous efforts have been devoted to the development of non-precious catalysts, especially spinel oxides, perovskite oxides, non-precious alloy catalysts, and metal-free catalysts [2, 7, 8]. Compared to precious metals and other catalysts, spinel oxides have demonstrated competitive electrocatalytic activities for OER [9, 10]. Direct spinel oxides can be described by the general formula AB₂O₄, where A is the divalent cation occupying the tetrahedral (T_{d}) sites and B is the trivalent cation occupying the octahedral (Oₕ) sites of a close-packed lattice formed by the oxygen anions [7, 11]. Some transition metal cations can occupy both T_{d} and Oₕ sites, hence the general formula may be written as (A_{1-δ}B_{δ})_{Td}[A_{δ}B_{2-δ}]_{Oh}O₄ where δ (0≤δ≤1) determines the degree of inversion of the binary spinel structures [12]. In addition, certain transition metals can assume two different oxidation states simultaneously, leading to the formation of redox couples within the spinel structure [10]. Consequently, the elemental composition, occupation of the crystallographic sites, and cation valence play a critical role in the spinel oxide crystal structure, physicochemical properties including the electrical conductivity and catalytic activity [10, 11, 13, 14].

Several works in the literature have related the electrocatalytic activity of spinel oxides for OER with the nature of the metal cations occupying the octahedral sites. For example, Co²⁺/Co³⁺ and Ni²⁺/Ni³⁺ redox couples have been typically considered the active sites for OER [14-16]. Since, the adsorption of the oxygen intermediates on the active sites involves the hybridization of the metal 3d-orbitals with the oxygen 2p-orbitals, a higher activity of spinel oxides for OER has also been correlated to a higher covalency of the bond formed between the oxygen species and the metal cation in the Oₕ site [17]. Although, the metal cations in the T_{d} sites are not considered active sites for this reaction, some recent works put in evidence their possible role on the oxygen electrocatalysis [18-20]. Since OER initiates with the reaction between surface cations and OH groups from the electrolyte and because the cations in the T_{d} and Oₕ sites share the same oxygen anion, Sun et al. proposed that the active site results from the bond dissociation with weaker covalency in the M_{Td}-O-M_{Oh} backbone [18]. Using a combination of experimental and computational studies, the authors found a volcano-like dependence of the OER activity of these oxides with the difference between the covalency of the bonds formed between the T_{d} and the Oₕ cations with the shared oxygen anion. Bergman et al. investigated the OER on crystalline Co₃O₄ in phosphate medium (pH=7) by in-situ X-ray techniques and revealed the formation of a sub-nanometer CoOₓ(OH)_{y} amorphous layer composed of di-μ-oxo-bridged Co³⁺/Co⁴⁺ ions on the top of the crystalline Co₃O₄ at high overpotentials. This layer which provides the active sites for the OER results from the reversible conversion of Co²⁺ ions in T_{d} coordination from the crystalline Co₃O₄ to Co³⁺ ions in Oₕ coordination in the amorphous structure. The authors also suggested that the stability and crystallinity of the metal oxide underneath amorphous structure play a critical role in preventing metal dissolution at high overpotentials, and hence, in the reversible transformation between the amorphous and crystalline phases. Similar findings were obtained by Wang et al [20].

From a literature survey, it was established that the OER activity in spinels is guided by the nature of the cations and their sites, which in turn can be exposed preferentially by specific crystalline facets. This can be met by nanocrystals having shapes exposing facets that are active. The shape and the type of facets exposed are controlled by the relative surface energy of the exposed lattice planes which in turn depends on the nature and the occupancy of the cations [21]. Spinel oxide nanocrystals are usually synthesized by co-precipitation or sol-gel techniques [22, 23], which offer excellent control of stoichiometry and particle size but produce aggregated and partly fused nanoparticles (NPs) with sluggish facets. Nanocrystals with sharp and controlled facets can be produced [24], but require long, complex preparation and energy-consuming steps, and are unsuitable for producing the large quantities for industrial-sized electrodes. In addition, an annealing process is required to increase the crystallinity and stability of the NPs, which generally leads to sintering and the loss of catalytic activity. Although sintering can be mitigated using capping agents, they generate waste, which is highly undesirable for large-scale production [25]. Hence, it remains challenging to rationally develop an efficient process to produce mixed spinel oxides with controlled composition and exposed facets over a wide composition range which is highly desired in structure-sensitive reactions.

### SUMMARY OF THE INVENTION

In accordance with the present invention, there is provided:
1. Nanoparticles of a ferrite of formula MnₓCo_{y}Ni_{z}Fe_{3-(x+y+z)}O₄, wherein each of x, y and z is ≥0 and ≤1, and wherein 0<(x+y+z)<1.5,
   wherein the ferrite has a spinel crystalline structure,
   wherein the nanoparticles have a truncated octahedron shape exposing facets, wherein said facets comprise 6 square facets and 8 hexagonal facets, wherein the square facets correspond to the {100} crystal plane and the hexagonal facets correspond to the {111} crystal plane, and
   wherein the nanoparticles are up to about 500 nm in size.
2. A catalyst comprising the nanoparticles of embodiment 1.
3. Use of the nanoparticles of embodiment 1 as a catalyst.
4. A composition for an electrode comprising the nanoparticles of embodiment 1
5. An electrode comprising the nanoparticles of embodiment 1.
6. An electrolytic cell comprising an electrode comprising the nanoparticles of embodiment 1 as an anode, a cathode as well as an electrolyte between the anode and the cathode.
7. The nanoparticles/catalyst/use/composition/electrode/electrolytic cell of any one of embodiments 1 to 6, wherein the catalyst and electrode are an Oxygen Evolution Reaction (OER) catalyst and an OER electrode.
8. The nanoparticles/catalyst/use/composition/electrode/electrolytic cell of any one of embodiments 1 to 7 for use in:
   in electrolytic cells e.g., for CO₂ electro-reduction, for H₂O₂ production, for N₂ reduction, and for the Electro-Fenton process,
   in Unitised Regenerative Fuel Cells (URFC), or
   in metal-air batteries.
9. The nanoparticles/catalyst/use/composition/electrode/electrolytic cell of any one of embodiments 1 to 8, wherein the nanoparticles/nanocrystals are at least about 90% crystalline, preferably at least about 95% crystalline, and most preferably wherein each nanoparticle is a nanocrystal.
10. The nanoparticles/catalyst/use/composition/electrode/electrolytic cell of any one of embodiments 1 to 9, wherein the lattice parameter of the spinel crystalline structure is about 8.4 Å.
11. The nanoparticles/catalyst/use/composition/electrode/electrolytic cell of any one of embodiments 1 to 10, wherein the lattice parameter of the spinel crystalline structure is from about 8.3887 Å to about 8.4368 Å, preferably from about 8.4041 Å to about 8.4368 Å, and most preferably from about 8.4041 Å to about 8.4222 Å.
12. The nanoparticles/catalyst/use/composition/electrode/electrolytic cell of any one of embodiments 1 to 11, wherein the facets exposed on the nanoparticles/nanocrystals further comprises {110} facets intersecting the {111} plane.
13. The nanoparticles/catalyst/use/composition/electrode/electrolytic cell of embodiment 12, wherein the {110} facets make up at most about 5%, preferably at most about 3%, and most preferably at most about 1% of the surface area of the nanoparticles/nanocrystals.
14. The nanoparticles/catalyst/use/composition/electrode/electrolytic cell of any one of embodiments 1 to 11, wherein the facets exposed on the nanoparticles/nanocrystals are free of {110} facets.
15. The nanoparticles/catalyst/use/composition/electrode/electrolytic cell of any one of embodiments 1 to 14, wherein the nanoparticles/nanocrystals are mostly free of {110} facets.
16. The nanoparticles/catalyst/use/composition/electrode/electrolytic cell of any one of embodiments 1 to 15, wherein z is at most about 0.5, preferably at most about 0.25, more preferably at most about 0.15 and most preferably z is about 0.
17. The nanoparticles/catalyst/use/composition/electrode/electrolytic cell of any one of embodiments 1 to 16, wherein y=1−x.
18. The nanoparticles/catalyst/use/composition/electrode/electrolytic cell of any one of embodiments 1 to 17, wherein 0<x<1, preferably about 0.15<x<about 0.75, more preferably about 0.25<x<about 0.50.
19. The nanoparticles/catalyst/use/composition/electrode/electrolytic cell of any one of embodiments 1 to 18, wherein x is about 0.5, and y is about 0.5, and z is about 0.
20. The nanoparticles/catalyst/use/composition/electrode/electrolytic cell of any one of embodiments 1 to 19, wherein the ferrite is of formula MnₓCo₁₋ₓFe₂O₄, wherein 0≤x<1.
21. The nanoparticles/catalyst/use/composition/electrode/electrolytic cell of embodiment 20, wherein 0<x<1, preferably about 0.15<x<about 0.75, more preferably about 0.25<x<about 0.50.
22. The nanoparticles/catalyst/use/composition/electrode/electrolytic cell of any one of embodiments 1 to 21, wherein the nanoparticles/nanocrystals are up to about 400 nm, preferably up to about 250 nm, more preferably up to about 125 nm, and most preferably up to about 80 nm in size.
23. The nanoparticles/catalyst/use/composition/electrode/electrolytic cell of any one of embodiments 1 to 22, wherein the nanoparticles/nanocrystals are at least about 5 nm in size, preferably at least about 10 nm, and more preferably at least about 20 nm in size.
24. The nanoparticles/catalyst/use/composition/electrode/electrolytic cell of any one of embodiments 1 to 23, wherein the nanoparticles/nanocrystals have a median side of about 20 nm to about 50 nm, preferably of about 30 nm to about 40 nm.
25. The nanoparticles/catalyst/use/composition/electrode/electrolytic cell of any one of embodiments 1 to 24, wherein the nanoparticles/nanocrystals have a homogeneous elemental composition.
26. The nanoparticles/catalyst/use/composition/electrode/electrolytic cell of any one of embodiments 1 to 25, wherein the nanoparticles/nanocrystals are free of a preferential segregation of Ni, Mn, Co, Fe, or O at the surface.
27. The nanoparticles/catalyst/use/composition/electrode/electrolytic cell of any one of embodiments 1 to 26, wherein the nanoparticles/nanocrystals have an average BET surface of about 0.4 m² g⁻¹ to about 0.7 m² g⁻¹, and preferably of about 0.46 m² g⁻¹ to about 0.64 m² g⁻¹.
28. The nanoparticles/catalyst/use/composition/electrode/electrolytic cell of any one of embodiments 1 to 27, wherein the nanoparticles/nanocrystals have an {100}/{111} area facet ratio of about 0.46 to about 0.64, preferably from about 0.4 to about 0.7, and most preferably about 0.46 to about 0.64.
29. The nanoparticles/catalyst/use/composition/electrode/electrolytic cell of any one of embodiments 1 to 28, wherein the ferrite comprises both Fe²⁺ and Fe³⁺ ions.
30. The nanoparticles/catalyst/use/composition/electrode/electrolytic cell of embodiment 29, wherein the Fe⁺³/ΣFe ratio is from about 0.50 to about 0.70, preferably about 0.55 to about 0.66.
31. The nanoparticles/catalyst/use/composition/electrode/electrolytic cell of any one of embodiments 1 to 30, wherein the nanoparticles/nanocrystals are self-supporting.
32. The nanoparticles/catalyst/use/composition/electrode/electrolytic cell of any one of embodiments 1 to 31, wherein the nanoparticles/nanocrystals are free of capping agents.
33. The nanoparticles/catalyst/use/composition/electrode/electrolytic cell of any one of embodiments 1 to 32, wherein the nanoparticles/nanocrystals are free of surfactants.

### BRIEF DESCRIPTION OF THE DRAWINGS

In the appended drawings:

FIG. 1 Inductively coupled radio-frequency plasma reaction chamber.

FIG. 2 Scheme of nanocrystal oriented in a) {100} and b) {110} direction. a and b represent dimensions used to compute the relative surface fraction, R.

FIG. 3 (a) Rietveld-refined X-ray diffractogram of sample Mn_{0.5}Co_{0.5}Fe₂O₄ (black line) and model (blackline circle marker). Bottom: reference JCPDF file (vertical black bars) and difference plot (fine black line).

(b) Detail of the peak assigned to the {113} planes for MnₓCo₁₋ₓFe₂O₄ with x=0, 0.25, 0.5, 0.75 and 1. Two MnFe₂O₄ phases are shown by two fitted peaks (plus and diamond sign) in the x=1 peak

(c) Linear change of the lattice parameter of the cubic lattice (left axis) and the measured EELS content of the nanoparticle (right axis) as a function of x. For MnFe₂O₄, two phases of different compositions were noted from the peak doubling.

FIG. 4 Particle size distribution of the different spinel oxides (top) and corresponding representative BF-TEM image of the facetted nanocrystals (bottom): (a) MnFe₂O₄, (b) Mn_{0.75}Co_{0.25}Fe₂O₄, (c) Mn_{0.5}Co_{0.5}Fe₂O₄, (d) Mn_{0.25}Co_{0.75}Fe₂O₄ and (e) CoFe₂O₄.

FIG. 5 (a) HREM micrograph of a representative NP found in sample Mn_{0.5}Co_{0.5}Fe₂O₄.

(b) Corresponding diffractogram of that NP in the (110) zone axis with the lattice planes indexed.

(c) Corresponding HAADF-STEM image and associated particle model (inset).

(d) STEM profile (grey area) taken along the black and white, in the direction in (c) showing the (11̅1) and the (1̅11̅) inclined facets and the vertex from which the dimension b was measured. The Mn, Co and Fe L_{2,3} EELS intensities are also plotted with scales and offsets adjusted to the STEM intensity.

(e) Background-subtracted EELS sum spectra exhibiting the O K, and the L2,3 edges of Mn, Fe and Co with corresponding background intensity models.

(f) Co, Mn, and Fe EELS intensity map.

(g) Co, Mn and Fe EELS intensity trivariate histogram plotted from all the pixels of the EELS map showing that the elemental composition distribution is tightly centered around a single value.

FIG. 6 (a) Mn spatial segregation in MnFe₂O₄ represented by a trivariate histogram produced with the O K, Fe L_{2,3} and Mn L2,3 EELS edges pixel intensity from an EELS map.

(b) Color mix map of three distinct composition ranges (region of interest, ROI) of the trivariate histogram.

FIG. 7 (a) Mn, Co and Fe contents obtained from EELS and XPS analysis. XPS core level spectra (b) Fe 2p_{3/2}, (c) Mn 2p_{3/2} and (d) Co 2p_{3/2} recorded for the series of MnₓCo₁₋ₓFe₂O₄ spinel oxides. The spectra were background subtracted and normalized against the intensity of the main peak.

FIG. 8 (a) Fe L2,3 edges EEL spectra recorded from MnₓCo₁₋ₓFe₂O₄ nanoparticles with x=0 (circle marker), 0.25 (square marker), 0.5 (plus marker), 0.75 (triangle right) and 1 (triangle left).

(b) Van Aeken function plot relating the L3/L2 ratio to Fe valence.

FIG. 9 Cyclic voltammograms of the spinel oxides (MnₓCo₁₋ₓFe₂O₄)+carbon composite electrodes in N₂-saturated 0.1 M KOH solution at a scan rate of 50 mV s⁻¹. Cycle number 40 is shown.

FIG. 10 Cyclic voltammograms of (a) C+MnFe₂O₄, (b) C+Mn_{0.75}Co_{0.25}Fe₂O₄, (c) C+Mn_{0.5}Co_{0.5}Fe₂O₄, (d) C+Mn_{0.25}Co_{0.75}Fe₂O₄, (e) C+CoFe₂O₄ and (f) carbon (C), recorded in N₂-saturated 0.1 M KOH at different scan rates for the determination of the double layer capacitance.

FIG. 11 (a) Estimation of the double layer capacitance (Ca) by plotting the average current density variation [Δj=(j_{anodic}−j_{cathodic})/2] at 1.15 V vs RHE as a function of the scan rate. The data was obtained from the cyclic voltammograms reported in FIG. 10.

Variation of the (b) C_{d} and (c) roughness factor according to the composition of the MnₓCo₁₋ₓFe₂O₄ spinel oxide composite electrodes.

FIG. 12 (a) OER polarization curves of Carbon, Pt/C, IrO₂/C and C+MnₓCo₁₋ₓFe₂O₄ composite electrodes in 0.1M KOH at 5 mV s-1 and 1600 rpm.

(b) OER polarization curves normalized for the roughness factor (Rf) of the electrodes. All curves were corrected for the ohmic drop.

FIG. 13 (a) Cyclic voltammograms of the C+Mn_{0.5}Co_{0.5}Fe₂O₄ composite electrode before and after 5000 potential cycles in O₂-saturated and N₂-saturated 0.1 M KOH.

(b) OER linear sweep voltammograms recorded at 5 mVs-1 and 1600 rpm in N₂-saturated 0.1M KOH.

(c) HRTEM micrograph of the electrode after stability test and (d) Corresponding diffractogram of that NP in the (114) zone axis with the lattice planes indexed.

(e) Co, Mn and Fe EELS intensity trivariate histogram plotted from all the pixels of the EELS map showing that the elemental composition distribution is tightly centered around a single value

(f) Mn EELS intensity map.

(g) Co EELS intensity map

(h) Fe EELS intensity map.

### DETAILED DESCRIPTION OF THE INVENTION

Turning now to the invention in more details, there is provided nanoparticles (preferably nanocrystals) of a ferrite of formula MnₓCo_{y}Ni_{z}Fe_{3-(x+y+z)}O₄, preferably MnₓCo₁₋ₓFe₂O₄, with specific crystalline structure, shape, and size. Together, these specific crystalline structure, shape, and size provide the electronic structure necessary to favor the oxygen evolution reaction (OER), and hence the performances of the nanoparticles as a catalyst, making them a viable alternative to noble metal oxide catalysts and Raney-Ni catalysts, which are the most typical catalysts for acidic and alkaline electrolytic cells.

There is also provided a catalyst comprising these nanoparticles as well as the use of these nanoparticles as a catalyst.

Preferably, the catalyst is used in an electrode. Therefore, there is also provided a composition for an electrode comprising these nanoparticles as well as an electrode comprising these nanoparticles. Preferably, the electrode is an anode.

The catalyst is active toward the oxygen evolution reaction. Hence, the catalyst and electrode are an OER catalyst and an OER electrode.

Also, the catalyst and electrode can be for use in electrolytic cells e.g., for CO₂ electro-reduction, for H₂O₂ production, for N₂ reduction, and for the Electro-Fenton process, in Unitised Regenerative Fuel Cells (URFC), and in metal-air batteries. Preferably, the catalyst and electrode are used in an electrolytic cell, such as a water electrolysis cell to produce hydrogen and O₂. There is therefore also provided an electrolytic cell comprising an anode comprising the invention, a cathode as well as an electrolyte between the anode and the cathode. In preferred embodiments, the electrolyte is basic.

The catalyst and electrode are used for the oxidation of alcohols (such as methanol, ethanol, glycerol), formic acid, organic pollutants in water (such as pesticides, dyes, estrogenes, hormones, etc.)

Preferably, the catalyst and electrode are used Typically, the electrodes in a rechargeable metal-air batteries (with only two electrodes) and URFC comprise a carbon material because the same electrode will operate as anode and cathode. Also, the catalysts, often supported on carbon black—otherwise mixed with—will be deposited on porous layers referred as gas diffusion layers (which often are carbon based). Graphitic carbon is typically preferred because of its higher corrosion resistance. In anodes of electrolyzers, in 3 electrodes rechargeable metal-air batteries and even in some URFCs, a porous non-carbon support (referred to as porous transport layer, PTL, in the case of electrolyzers) is generally used because carbon will be oxidized at high operating voltages (conditions of OER). In general, catalyst nanoparticles are deposited directly on the PTL and an ionomer or a polymer binder is used to hold the nanoparticles to the PTL.

Therefore, in some embodiments, the electrode/composition for an electrode further comprises a carbon material such as:
carbon black,
porous carbon materials, fullerenes, carbon nanotubes, carbon fibers, carbon filaments, carbon xerogel, carbon aerogel, nanocage carbons, carbon nanohorns, carbon nano-onions, carbon nano-capsules, and their graphitic forms,
graphene-type materials (monolayer graphene, few layers graphene materials, reduced graphene oxide, graphene oxide),
heteroatom (N, S, P) doped carbon and graphene-type materials, and
carbon nitride and graphitic carbon nitride.

Also, in some embodiments, the electrode further comprises a porous transport layer. In some embodiments, especially for electrolyzers, the porous transport layer is e.g., a frit, foam, mesh, felt, or woven metal network of Ni, Ti, stainless still, titanium carbide, or Au. In other embodiments, especially for URFCs, the porous transport layer is made of M-TiO₂, WO₃, S—ZrO₂, Sn—In₂O₃, WC, TiₙO₂ₙ₋₁, TiC, or TiCN.

In some embodiments, the electrode/composition for an electrode further comprises a binder, such as polytetrafluoroethylene, fluorinated ethylene propylene polymers, anion exchange ionomers (formed by an ion exchange head group on a polymer backbone). Preferred ion exchange head groups include: quaternary ammonium (such as alkyltrimethylammonium, benzyltrimethylammonium), tertiary diamines, substituted imidazoliums ((benz)imidazolium), guanidinium, piperidinium cation, pyridinium, phosphonium and sulphonium, and ligand-metal complexes.

In embodiments, the electrode further comprises a porous layer supporting the above composition, preferably the composition is spread on the support.

The Examples below show that, when used in electrode, the ferrite nanocrystals of the invention (especially those with x=0.25 and 0.5, and most particular those with x=0.5) have excellent activity toward oxygen evolution.

In fact, an overpotential of only 420 mV was needed to achieve an OER current density of 10 mA cm⁻², which is among the most competitive results reported until now for ferrites. Also, a current density of 10 mA cm⁻² (the most widely accepted benchmark to compare the OER performance of electrodes) was achieved at 1.65 V vs RHE for the two electrodes. At the same time, the onset potential of the electrodes (1.56 V, j=1.0 mA cm⁻²) was very close to that of the IrO₂/C electrode (1.54 V, j=1.0 mA cm⁻²), which is the gold standard in the field (for acidic electrolytic cells) and is much more expensive.

These performances are significant, especially when considering that the nanocrystals in the Examples have a relatively low specific surface as well particle sizes ranging from 20 to 80 nm (with a 40 nm diameter median size) while other spinel ferrites nanoparticles are typically of much smaller particle size (e.g., less than 10 nm).

In fact, the electrolytic activity of the nanoparticles of the invention is comparable to or larger than those of other self-supported spinel catalysts with sizes <20 nm, for example see below:

| Reference | Performance |
|---|---|
| Chakrapani et al., The Role of Composition of Uniform and | The best catalyst - CoV_{1.5}Fe_{0.5}O₄ - exhibits a |
| Highly Dispersed Cobalt Vanadium Iron Spinel Nanocrystals | potential of 1.54 V vs RHE @ 10 mA/cm² in KOH 1M |
| for Oxygen Electrocatalysis, ACS Catal. 2018, 8, 2, 1259- | (Note that catalyst performances increase with the |
| 1267 | KOH concentration.) |
| K. Chakrapani, G. Bendt, H. Hajiyani, I. Schwarzrock, T. | The best catalyst - Co_{0.5}Ni_{0.5}Fe₂O₄ - exhibits a |
| Lunkenbein, S. Salamon, J. Landers, H. Wende, R. Schlögl, | potential of 1.56 V vs RHE @ 10 mA/cm₂ in KOH 1M |
| R. Pentcheva, Role of composition and size of cobalt ferrite | |
| nanocrystals in the oxygen evolution reaction, | |
| ChemCatChem, 9 (2017) 2988-2995 | |
| A. Indra, P. W. Menezes, N. R. Sahraie, A. Bergmann, C. Das, | The crystalline catalyst Fe₂CoO₄ (8-16 nm in size, |
| M. Tallarida, D. Schmeiβer, P. Strasser, M. Driess, | specific surface area of 83 m²g⁻¹) exhibits a |
| Unification of catalytic water oxidation and oxygen reduction | potential of 1.79 V vs RHE @ 10 mA/cm²_{oxyde}. |
| reactions: amorphous beat crystalline cobalt iron oxides, | The amorphous catalyst Fe₂Co_{3.66} (2-8 nm in size, |
| Journal of the American Chemical Society, 136 (2014) | specific surface area of 127 m²g⁻¹) exhibits a |
| 17530-17536. | potential of 1.72 V vs RHE @ 10 mA/cm²_{oxide}. |

The electrolytic activity of the nanocrystals of the invention is comparable to or larger than those of other spinel catalysts with either unique morphologies and/or large surface areas, for example see below:

| Reference | Performance |
|---|---|
| Yujiao Xu, Weiyong Bian, Jiao Wu, Jing-Hua Tian, | Hollow nanospheres of CoFe₂O₄ (size of 400 nm to |
| Ruizhi Yang, Preparation and electrocatalytic activity of | 1.0 μm with a wall thickness of about 130 nm and a |
| 3D hierarchical porous spinel CoFe₂O₄ hollow | specific surface area of 103.73 m²g⁻¹) exhibits a |
| nanospheres as efficient catalyst for Oxygen Reduction | potential of 1.68 V vs RHE @ 10 mA/cm² in KOH 0.1M. |
| Reaction and Oxygen Evolution Reaction, | Hollow nanospheres of CoFe₂O₄ (size of 400 nm to |
| Electrochimica Acta, Volume 151, 2015, Pages 276-283, | 1.0 μm with a specific surface area of 75.09 m²g⁻¹) |
| ISSN 0013-4686, | exhibits a potential of 1.74V vs RHE @ 10 mA/cm² in |
| https://doi.org/10.1016/j.electacta.2014.11.042 | KOH 0.1M. |
| Li et al., Facile synthesis of electrospun MFe₂O₄ (M = | MFe₂O₄ (M = Co, Ni, Cu, Fe) nanofibers with lengths up |
| Co, Ni, Cu, Mn) spinel nanofibers with excellent | to several dozens of micrometers with an average |
| electrocatalytic properties for oxygen evolution and | diameter size of about 150 nm, and a specific surface |
| hydrogen peroxide reduction, Nanoscale, 2015, 7, 8920- | area of about 60 m2g − 1, exhibits a potential of 1.64- |
| 8930 | 1.74 V vs RHE @ 5 mAcm⁻². |
| Yan et al., One-pot synthesis of monodispersed porous | CoFe₂O₄ nanospheres 70 nm in size, made of |
| CoFe₂O₄ nanospheres on graphene as an efficient | individual nanoparticles 3 to 10 nm in size, dispersed |
| electrocatalyst for oxygen reduction and evolution | on reduced graphene oxide exhibits a potential of 1.73 |
| reactions, RSC Adv., 2016, 6, 307-313 | V vs RHE @ 10 mAcm⁻². |

The electrolytic activity of the nanocrystals of the invention is comparable to or larger than those of other spinel catalysts supported on carbon black and having particle size <10 nm as well as other catalyst, for example see below:

| Reference | Performance |
|---|---|
| Zhou, Y., Du, Y., Xi, S. et al. Spinel Manganese | MnFe₂O₄ exhibits a tension of 1.75 V vs RHE @ 10 |
| Ferrites for Oxygen Electrocatalysis: Effect of Mn | mA/cm² in KOH 0.1M |
| Valency and Occupation Site. Electrocatalysis 9, 287- | |
| 292 (2018). | |
| Y. Sun, H. Liao, J. Wang, B. Chen, S. Sun, S. J. H. Ong, | In this paper, spinel AlMn₂O₄ is expected to be the |
| S. Xi, C. Diao, Y. Du, J.-O. Wang, Covalency | spinel catalyst with the highest electrocatalytic activity |
| competition dominates the water oxidation structure- | reported in the scientific literature. The catalyst is |
| activity relationship on spinel oxides, Nature Catalysis, | synthesized, mixed with carbon black and tested for the |
| 3 (2020) 554-563 | OER in KOH 0.1M. The particle size and the specific |
| | surface area are not mentioned. The polarisation curve |
| | for OER (FIG. S9) exhibits a tension of 0.2 mA @ |
| | 1.8 V, which corresponds to 1 mA/cm² @ 1.8 V. |
| | According to these figures, the catalyst performance is |
| | very low. |
| Görlin et al., Tracking Catalyst Redox States and | the catalyst with the highest activity presented by this |
| Reaction Dynamics in Ni—Fe Oxyhydroxide Oxygen | research group - Ni₄₅Fe₅₅ supported on carbon black |
| Evolution Reaction Electrocatalysts: The Role of | (specific surface area 182 m²/g) - exhibits a potential of |
| Catalyst Support and Electrolyte pH, J. Am. Chem. | 1.5 V vs RHE @10 mA/cm² in 0.1M KOH. |
| Soc. 2017, 139, 5, 2070-2082 | |
| Geng et al., Precious-Metal-Free Co—Fe—O/rGO | The catalyst Co—Fe—O (2 Co:1 Fe) made of |
| Synergetic Electrocatalysts for Oxygen Evolution | nanoparticles dispersed on reduced graphene oxide |
| Reaction by a Facile Hydrothermal Route, Volume 8, | exhibits a potential of 1.57 V vs RHE @ 10 mAcm⁻². |
| Issue 4, February 2015, Pages 659-664 | |

Moreover, the nanocrystals of the invention demonstrated to possess remarkable potential cycling stability for up to 5000 cycles, with no significant variations of their structure and morphology.

Therefore, the present invention provides a pathway to the development of cost-effective bifunctional spinel ferrite oxides for oxygen electrocatalysis to substitute noble metals. The present invention is a promising alternative to replace commercial IrO₂/C catalysts and holds great potential in applications such as those noted above.

### Nanocrystals

As noted above, there are provided nanoparticles of a ferrite of formula MnₓCo_{y}Ni_{z}Fe_{3-(x+y+z)}O₄, wherein each of x, y and z is ≥0 and ≤1, and wherein 0<(x+y+z)<1.5,
wherein the ferrite has a spinel crystalline structure,
wherein the nanoparticles have a truncated octahedron shape exposing facets, said facets comprising 6 square facets and 8 hexagonal facets, wherein the square facets correspond to the {100} crystal plane and the hexagonal facets correspond to the {111} crystal plane, and
wherein the nanoparticles are up to about 500 nm in size.

In preferred embodiments, the nanoparticles/nanocrystals are at least about 90% crystalline, preferably at least about 95% crystalline. In most preferred embodiments, each nanoparticle is a nanocrystal.

As well known to the skilled person, the space group for a spinel is Fd3̅m and the spinel crystalline structure comprises cubic close-packed oxides with eight tetrahedral (Tₕ) sites and four octahedral (Oₕ) sites per formula unit. The tetrahedral spaces are smaller than the octahedral spaces.

In embodiments, the lattice parameter of the spinel crystalline structure is about 8.4 Å. More specifically, the lattice parameter may be from about 8.3887 Å to about 8.4368 Å, preferably from about 8.4041 Å to about 8.4368 Å, and most preferably from about 8.4041 Å to about 8.4222 Å and is a function of x, y and z.

Furthermore, the skilled person also knows that a truncated octahedron is the solid that arises from a regular octahedron by removing six pyramids, one at each of the octahedron's vertices. The truncated octahedron thus has 14 facets (8 hexagons and 6 squares), 36 edges, and 24 vertices. Typically, the facets are sharp and flat.

It is possible that the facets exposed on the nanoparticles/nanocrystals further comprises {110} facets intersecting the {111} plane. For example, such {110} facets could make at most about 5%, preferably at most about 3%, and most preferably at most about 1% of the surface area of the nanoparticles/nanocrystals. In preferred embodiments, the facets exposed on the nanoparticles/nanocrystals are free of {110} facets.

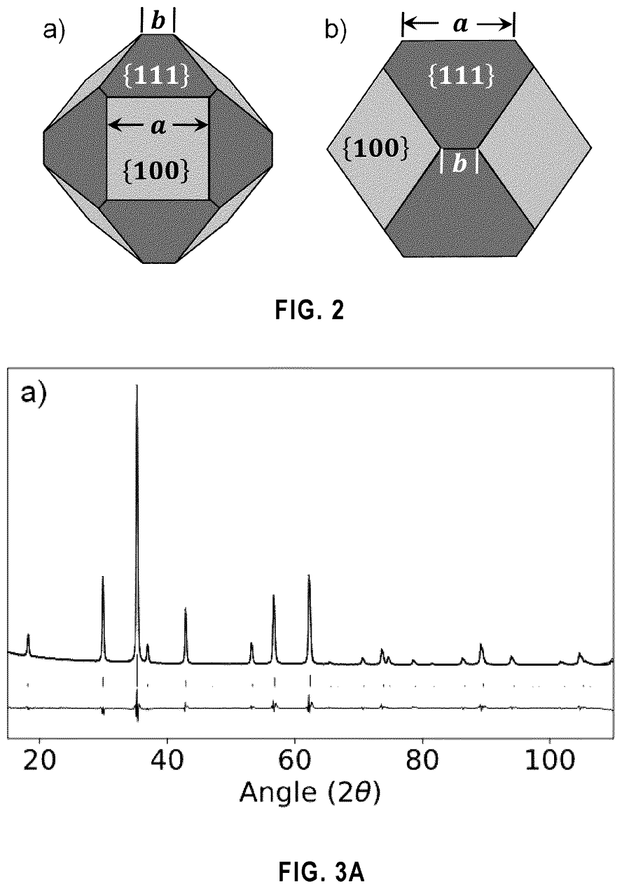

Note that the hexagons do not need to be regular as shown in FIG. 2.

Also note that a truncated octahedron can also be called a bitruncated cube (not to be confused with truncated cube, which is something else). A truncated octahedron with its facets labeled {111} and {100} is shown in FIG. 2a.

In preferred embodiments, z is at most about 0.5, preferably at most about 0.25, and more preferably at most about 0.15. In more preferred embodiments, z is about 0.

In more preferred embodiments, y=1-x.

In preferred embodiments, 0<x<1, preferably about 0.15<x<about 0.75, more preferably about 0.25<x<about 0.50.

In most preferred embodiments, x is about 0.5, and y is about 0.5, while z is about 0.

In the more preferred embodiments in which z=0 and y=1-x, the ferrite is of formula MnₓCo₁₋ₓFe₂O₄, wherein 0≤x<1. When 0<x<1, the ferrite is a mixed ferrite (of Mn and Co). In preferred embodiments, 0<x<1, preferably about 0.15<x<about 0.75, more preferably about 0.25<x<about 0.50.

In preferred embodiments, the nanoparticles/nanocrystals are up to about 400 nm, preferably up to about 250 nm, more preferably up to about 125 nm, and most preferably up to about 80 nm in size.

In preferred embodiments, the nanoparticles/nanocrystals are at least about 5 nm in size, preferably at least about 10 nm, and more preferably at least about 20 nm in size.

In preferred embodiments, the nanoparticles/nanocrystals have a median side of about 20 nm to about 50 nm, preferably of about 30 nm to about 40 nm.

In preferred embodiments, the nanoparticles/nanocrystals have a homogeneous elemental composition, i.e., they do not exhibit measurable elemental segregation. In other words, the composition of the ferrite is homogeneous throughout each nanoparticle/nanocrystal. Preferably, the composition of the ferrite is constant for all nanoparticles/nanocrystals. More preferably, the nanoparticles/nanocrystals are free of a preferential segregation of Ni, Mn, Co, Fe, or O at the surface.

Of note, other methods of manufacture (e.g., sol-gel methods, coprecipitation, hydrothermal methods, solvothermal methods) tend to produce nanoparticles presenting elemental gradients, i.e., the composition of the ferrite changes depending on its position in the volume of the nanoparticles.

In preferred embodiments, the nanoparticles/nanocrystals have an average BET surface of about 0.4 m² g⁻¹ to about 0.7 m² g⁻¹, and preferably of about 0.46 m² g⁻¹ to about 0.64 m² g⁻¹.

In preferred embodiments, the nanoparticles/nanocrystals have an {100}/{111} area facet ratio of about 0.46 to about 0.64, preferably from about 0.4 to about 0.7, and most preferably about 0.46 to about 0.64.

In preferred embodiments, the ferrite comprises both Fe²⁺ and Fe³⁺ ions. In preferred such embodiments, the Fe⁺³/ΣFe ratio is from about 0.50 to about 0.70, preferably about 0.55 to about 0.66.

In preferred embodiments, the nanoparticles/nanocrystals are self-supporting. In other words, they are free of a support, for example a carbon support, which is often required for other catalyst or other methods of manufacture.

In preferred embodiments, the nanoparticles/nanocrystals are free of capping agents, which are often required for other methods of manufacture.

In preferred embodiments, the nanoparticles/nanocrystals are free of surfactants, which are often required for other methods of manufacture.

### Manufacture of the Nanoparticles/Nanocrystals

The nanoparticles/nanocrystals of the invention can be produced by induction thermal plasma as described in Example 1 below. Namely, the nanoparticles/nanocrystals were produced from Fe, Mn, and Co nitrate precursors. It is envisioned that the particles could be produced by flame pyrolysis followed by flash quenching (to limit their size).

The induction thermal plasma method of manufacture has several advantages.

One advantage of this method is that it does not require a support, for example a carbon support. Indeed, most catalysts are produced on a carbon support to avoid agglomeration, limit the particle size, and to increase electrode conductivity (since most metal oxides are semiconductors).

Another advantage is that it does not require capping agents (e.g., oleamine) or surfactants. These are often used to limit the particle size.

Also, many methods do not produce a crystalline product and the catalyst must be annealed to become crystalline. However, such annealing undesirably increases particle size.

### Definitions

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted. In contrast, the phrase “consisting of” excludes any unspecified element, step, ingredient, or the like. The phrase “consisting essentially of” limits the scope to the specified materials or steps and those that do not materially affect the basic and novel characteristic(s) of the invention.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or plus or minus 5% of the numerical value qualified.

Unless otherwise defined, all technical and scientific terms used herein have the same meaning as commonly understood by one of ordinary skill in the art to which this invention belongs.

Other objects, advantages and features of the present invention will become more apparent upon reading of the following non-restrictive description of specific embodiments thereof, given by way of example only with reference to the accompanying drawings.

### DESCRIPTION OF ILLUSTRATIVE EMBODIMENTS

The present invention is illustrated in further details by the following non-limiting examples.

### Example 1-Oxygen Evolution Reaction of Facetted MnₓCo₁₋ₓFe₂O₄ Nanoparticles Prepared by Induction Thermal Plasma Synthesis

Here, thermal plasma induction, a scalable process capable of producing high-quality oxide nanoparticles, is used to synthesize mixed spinel ferrites MnₓCo₁₋ₓFe₂O₄ (0≤x<1) with high crystallinity and homogeneous elemental composition down to the atomic level. The oxide nanoparticles have a median particle size of 40 nm and a well-defined truncated octahedron shape with {100} and {111} facets mainly exposed. Oxygen evolution studies in alkaline solution (0.1 M KOH) reveal the highest activity for carbon+Mn_{0.5}Co_{0.5}Fe₂O₄ composite electrode. An overpotential of only 420 mV is needed to achieve an OER current density of 10 mA cm⁻², which is among the most competitive results in ferrites reported until now. The OER activity was correlated with the presence of

$${Co}_{Td}^{2 +} / {Co}_{Oh}^{3 +}$$

couple in the spinel structure as demonstrated by XPS.

Namely, we report herein the synthesis of facetted individual nanocrystals of MnₓCo₁₋ₓFe₂O₄ nanoparticles (0≤x<1) and the study of their electrocatalytic activity for OER in alkaline medium (0.1 M KOH). Further, we demonstrate that OER performance of plasma-produced Mn_{0.5}Co_{0.5}Fe₂O₄ with particle sizes from 20 to 80 nm (with a 40 nm diameter median size) is significant when compared to other spinel ferrites of much smaller particle size (typically less than 10 nm). Finally, this spinel oxide demonstrated to possess outstanding potential cycling stability.

Our work provides a pathway to the development of cost-effective bifunctional spinel ferrite oxides for oxygen electrocatalysis to substitute noble metals.

### EXPERIMENTAL

### Synthesis of the Oxide Catalysts

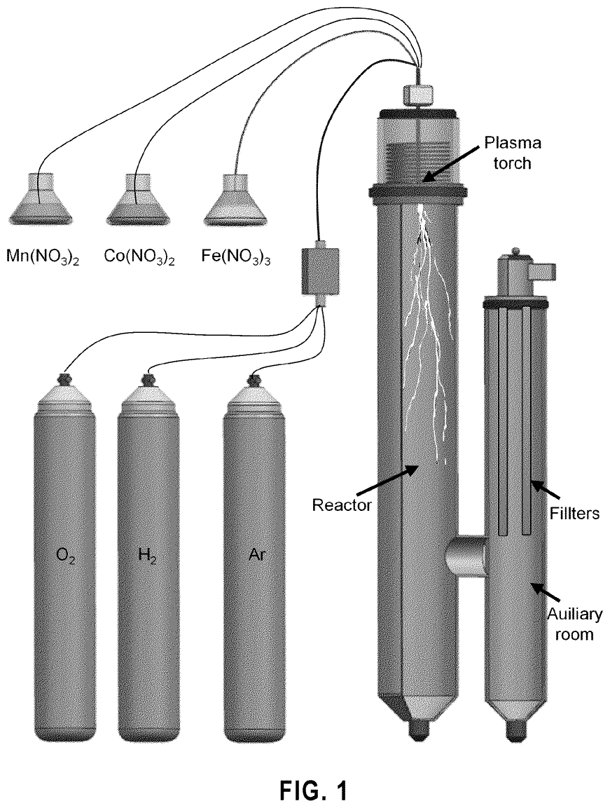

The oxide nanoparticles were synthesized in an induction thermal plasma reaction setup [33], FIG. 1. The plasma torch was positioned on top of a water-cooled cylindrical chamber (main reactor) and connected to a 3 MHz RF power supply. The precursors were injected coaxially with an atomization probe centered in the plasma torch. The main reactor was connected to another water-cooled cylindrical chamber (auxiliary chamber) which contained four microporous filters connected to a vacuum pump. The main reactor was designed to recirculate the NPs several times into the high-temperature region while the auxiliary chamber generated a cyclone that captured fluidized particles. It has been previously reported that there is a difference in morphology and composition between the NPs collected in the main and the auxiliary reactor [28]. Therefore, only the NPs collected in the auxiliary reactor have been tested for their catalytic activity.

The nanocrystals were produced following a procedure already reported previously by some of us for the synthesis of NiFeO₂ [26, 28, 34] and Cu_{0.5}Ni_{0.5}Fe₂O₄ [28]. Briefly, an aqueous solution of metal precursors (0.65 mol L⁻¹ of Fe(NO₃)₃·9H₂O, Co(NO₃)₂·6H₂O and Mn(NO₃)₂·4H₂O) in a metal molar ratio of 8:0:4, 8:1:3, 8:2:2, 8:3:1 and 8:4:0) was injected into the inductively coupled thermal plasma torch using Ar as carrier gas. The precursor solution was pumped into a water-cooled gas atomization probe using a peristaltic pump at 5 mL min-1. A sheath gas of Ar/O₂ was used to control the trajectory of the NPs and provide an oxidizing atmosphere. The gases were injected at a controlled rate of 62 slpm of O₂ and 5.5 slpm of Ar for the sheath gas, and 10 slpm Ar for the carrier gas. Before reaction, the reactor base pressure was set to 180 Torr. Upon evaporation of H₂O as the carrier solvent of the precursors in the main chamber, homogeneous nucleation of nanoparticles occurs by precursor supersaturation in the plasma phase. During recirculation, the NPs undergo several melting, quenching, and annealing cycles, favoring crystalline particle growth. As NPs accumulated on the filters, the pressure increased to 300 Torr inside the reactor. After 3 h 20 min of reaction, the resulting NPs were collected separately from the main and the auxiliary chambers.

### Structural Characterization

X-ray diffraction analysis was performed on an X′Pert PRO Multipurpose Diffractometer from PANalytical with the Bragg-Brentano geometry and a PIXel1D detector. XRD patterns were collected over a 20 range of 15° to 108° with a step size of 0.0131° and 2.2 s step-1. The low level of the pulse-height discrimination was raised to 43% to remove the fluorescence. Rietveld refinement was performed with the PANalytical software HighScore Plus (V3.0.5) using pseudo-Voight functions.

N₂-sorption measurements were performed in a Micromeritics ASAP 2020 adsorption analyzer at 77 K. The sample was pretreated at 383 K and 1 mPa overnight.

### Transmission Electron Microscopy-Imaging

The basic NPs morphological study was carried out by transmission electron microscopy (TEM) using Hitachi H-7500 operated at 120 kV. For the bright-field TEM (BF-TEM) images, samples were deposited on 400 mesh carbon-coated (lacey) copper grids supplied by Electron Microscopy Sciences. High resolution TEM, high-angle annular dark field scanning TEM (HAADF-STEM) were acquired on a FEI Titan 80-300 equipped with an XFEG source at 200 keV. In this case, the NPs were dispersed into ethanol and sonicated, and one drop of the NP/ethanol dispersion was deposited onto a 200-mesh holey carbon-coated Cu grid and left to dry. The sample was then plasma cleaned at 50 W for 3 min.

### Facet Ratio Determination

Here, the method used to determine, R, the {111} to {100} ratio of exposed facets is explained. The bitruncated octahedron structure comprises 6 {111} squared facets and 8 {100} hexagonal facets. When the particles are in the {100} or the {110} projections (FIG. 2) two distinct vertices can be measured from the micrographs: a, the side of the {100} square and b, the vertice at the intersection of two adjacent {111} facets.

The total area of the 6 {100} facets are thus A_{{100}}=6a², and it can be shown by simple geometry that the total area of the 8 {111} facets is

$${A}_{\{ 111 \}} = \frac{\sqrt{3}}{4} [ {a}^{2} + 4 ab + {b}^{2} ] .$$

Therefore, the ratio of facets can be easily computed:

$$R = \frac{{A}_{\{ 111 \}}}{{A}_{\{ 100 \}}} = \frac{1}{\sqrt{3}} \frac{[ {a}^{2} + 4 ab + {b}^{2} ]}{{a}^{2}} \qquad ( 1 )$$

### Electron Energy-Loss Spectroscopy (EELS)

The O, Fe, Mn, Co elemental quantification was carried out using the EELS cross-sections ratio calculated from MnO, Fe₃O₄, and CoO standards purchased from Sigma Aldrich and analyzed in the same conditions as the Co, Mn ferrites in this study [35, incorporated herein by reference]. The standards were grinded in a mortar and suspended in ethanol from which a drop was left to dry on a holey-carbon TEM grid. The OK, Mn L_{2,3}, Fe L_{2,3} and Co L_{2,3} EELS core-loss edges collected with a 200.0 kV acceleration voltage with a Gatan 966 Image Filter configured with a 55 mrad collection semi-angle and 19.1 mrad convergence semi-angle.

The EELS maps were filtered to remove X-ray spikes and aligned so that the Fe L3 maximum coincides, at 708 eV. For each edge, overlapping ELNES tails and the plural scattering background were removed by fitting a power-law. Care was taken to position the background window to extrapolate the Co edges that avoided the Fe core loss L₁ edge. The integration windows for O K, Mn L_{2,3}, Fe L_{2,3} and Co L_{2,3} were set to 14, 17, 22 and 21.5 eV, respectively. Care was taken to position the background window for the background extrapolation of Co that avoided the Fe L₁ edge. The same quantification scheme was used for CoO, Fe₃O₄, and MnO standards, sum spectra of individual particles and for spectra extracted from multivariate histograms. The overall composition was obtained from the analysis of several spectral-image maps of individual nanocrystals from each sample.

### X-Ray Photoelectron Spectroscopy

The X-ray photoelectron spectra were recorded using a VG Escalab 220i-XL using Mg-Kα polychromatic radiation (hv=1253.6 eV) operating at 15 kV and 26.6 mA. The signal was filtered with a hemispherical analyzer (pass energy=20 eV) for the high-resolution scans, and the detection was performed with a multi-channel detector. The main chamber pressure was kept at ≤10-9 Torr during measurements. The binding energy of the spectra was calibrated to the Carbon 1s peak at 284.6 eV. The surface at % of Fe, Co and Mn were determined by integrating the entire 2p core level spectra, and the areas were normalized by the appropriate atomic sensitivity factors.

### Electrochemical Characterization

A Princeton applied research 273A potentiostat and a rotating disk electrode (RDE) controller (AFMSRCE, Pine Instrument Co.) were used for the electrochemical tests. A single compartment electrochemical cell was equipped with the working electrode, a Pt coil as the counter electrode and a saturated calomel electrode as the reference electrode. All potentials in this work are referred to the reversible hydrogen electrode (RHE) by using the conversion formula, E vs RHE=E vs SCE+0.994V [7]. The electrode was calibrated in a hydrogen saturated 0.1M KOH solution (pH=12.56). The working electrode consisted of a glassy carbon electrode (GCE, Pine Instrument Co., 5 mm of diameter) covered by the catalyst layer. Prior to the catalyst layer deposition, the GCE was polished on suede with 0.3 and 0.05 μm Al₂O₃ powder, rinsed with double distilled water, and washed thoroughly in an ultrasound bath. The quality of the GCE surface was checked by cyclic voltammetry in N₂-saturated 1 mM K₃[Fe(CN)₆] solution in 0.1 M KCl (anodic peak to cathodic peak separation less than 70 mV). Then, the GCE was rewashed in the ultrasonic bath and dried at room temperature.

Catalyst layers were prepared by dispersing 4.0 mg of MnₓCo₁₋ₓFe₂O₄ powders and 8.0 mg of Carbon Vulcan XC-72 in a 1 ml of a water:isopropyl alcohol:Nafion 5 wt % (9:40:1 vol. ratio) solution, under ultrasound for more than one hour at room temperature. Then, 10 μL of the suspension were drop-cast onto the GCE and left to dry in air at room temperature. The spinel oxide/carbon electrodes were first conditioned by cyclic voltammetry in N₂ saturated 0.1 M KOH aqueous solution at a scan rate of 50 mV s⁻¹, in the potential window comprised between 0.2 V and 1.2 V vs RHE for a total of 40 cycles.

Afterwards, the cyclic voltammograms were recorded in a narrow potential window, between 1.1 and 1.2 V vs RHE, at different scan rates. Then, the double-layer capacitance (C_{dl}) of the composite electrodes/electrolyte interface was determined by plotting the average current density [Δj/2=(j_{anodic}−j_{cathodic})/2] at 1.15 V vs RHE as a function of the scan rate. The roughness factor (Rf) value for each composite electrode was estimated from the ratio between the experimental double-layer capacitance, determined by cyclic voltammetry

$${C}_{dl}^{CV}$$

and the theoretical one

$${C}_{d l}^{t h} ,$$

assuming 8 μF cm⁻² for carbon Vulcan and 60 μF cm⁻² for the oxide [36-39]:

$${R}_{f} = \frac{{C}_{dl}^{CV}}{{C}_{dl}^{th}} = \frac{{C}_{dl}^{CV}}{\frac{1}{3} \cdot 60 + \frac{2}{3} \cdot 8} \qquad ( 2 )$$

LSVs were conducted at 5 mV s⁻¹ in N₂-saturated 0.1 M KOH electrolyte for the OER performance. Commercial Pt/C and IrO₂ catalysts were tested for OER and used as references. The catalyst inks were prepared with 3.0 mg mL⁻¹ of 20% Pt/C (EC-20-PTC, ElectroChem) and 10.0 mg mL⁻¹ of 20% IrO₂/C (Alfa Aesar), and the Pt and IrO₂ loading on the GCEs was calculated to be 15.0 μg cm⁻² and 51.0 μg cm 2, respectively.

To test the endurance of the spinel catalysts to potential cycling, the following protocol was adopted for Mn_{0.5}Co_{0.5}Fe₂O₄. First, 20 mg of the oxide were dispersed in 1 mL of isopropanol, and then 25 UL of the dispersion was drop-cast onto the surface of a clean GCE. Afterward, the thin oxide layer was subjected to 5000 cycles between 0.908 and 0.408 V vs RHE in O₂-saturated 0.1 M KOH electrolyte. This was repeated 10 times on fresh oxide layers to obtain enough oxide powder to be tested for OER in the standard carbon-oxide thin film electrode. The electrodes with the aged catalyst were prepared and tested for OER as described above. Finally, the aged Mn_{0.5}Co_{0.5}Fe₂O₄ spinel nanoparticles were also analyzed by HR-TEM and EELS, as previously described.

### Results and Discussion

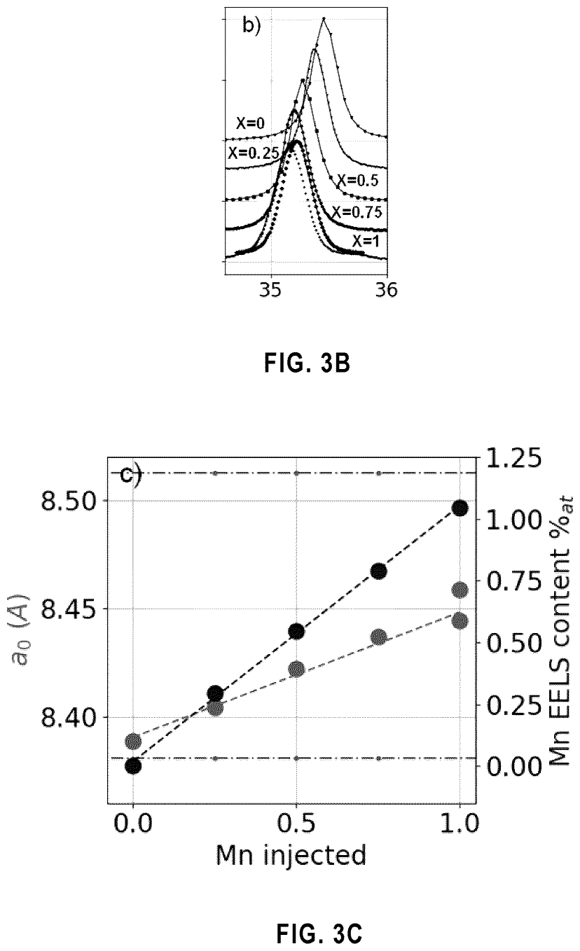

The structure and surface chemical composition of electrocatalysts play a critical role in their OER activity. The crystal structures of the MnₓCo₁₋ₓFe₂O₄ spinel oxides were investigated by X-ray diffraction, as shown in FIG. 3a. Theoretical X-ray diffraction patterns were modeled with the phases CoFe₂O₄ and MnFe₂O₄ (both Fd3m, no 227) based on the JCPDS cards no. 04-016-3954 and 04-013-6574, respectively. The scale factor, the lattice parameter (a₀), the Caglioti parameters, and the zero shift were obtained from the Rietveld refinement detailed in Table 1.

A single MnₓCo₁₋ₓFe₂O₄ solid solution could be fitted for each diffractogram, except for MnFe₂O₄. In this case, we observed a peak doubling that was consistent with the existence of two phases with distinct composition: 78% Mn_{0.28}Fe_{2.39}O₄ and 22% Mn_{0.44}Fe_{2.23}O₄. FIG. 3b shows the shift in the {113} crystal planes towards smaller angles with increasing Mn. This translates to a linear variation of the a₀ with the Mn content, as expected from Vegard's law, FIG. 3c. Using a Caglioti function, the crystallite size was fitted to the 23-42 nm range (Table 1). This value is consistent with the average BET surface area of 24 m² g⁻¹ which corresponds to NPs with an average ~25 nm diameter, assuming a spherical shape.

TABLE 1
RietveId refinement of the X-ray diffraction patterns of the spinel oxides MnₓCo₁₋ₓFe₂O₄

| | x in MnₓCo₁₋ₓFe₂O₄ | | | | | | | | | | |
|---|---|---|---|---|---|---|---|---|---|---|---|
| | 0 | | 0.25 | | 0.5 | | 0.75 | | 1 | | |
| | Phase(s) | | | | | | | | | | |
| | CoFe₂O₄ | | Co_{0.75}Mn_{0.25}Fe₂O₄ | | Co_{0.5}Mn_{0.5}Fe₂O₄ | | Co_{0.25}Mn_{0.75}Fe₂O₄ | | Mn_{0.28}Fe_{2.39}O₄ | | Mn_{0.44}Fe_{2.23}O₄ |
| Fraction | 100 | | 100 | | 100 | | 100 | | 77.6 | | 22.4 |
| (wt %) | | | | | | | | | | | |
| a₀ (Å) | 8.3887 | (4) | 8.4041 | (1) | 8.4222 | (1) | 8.4368 | (4) | 8.4123 | (8) | 8.4441(0) |
| U | 0.0415 | (3) | 0.1018 | (6) | 0.0509 | (2) | 0.0512 | (0) | 0.7310 | (5) | 0.6850(0) |
| W | 0.0515 | (3) | 0.0549 | (0) | 0.0609 | (2) | 0.0612 | (0) | 0.1620 | (1) | 0.0860(4) |
| V | 0.2454 | (0) | 0.2457 | (5) | 0.2449 | (6) | 0.2424 | (4) | 0.2341 | (7) | 0.2432(5) |

| | | | | | |
|---|---|---|---|---|---|
| C.S. (Å) | 377.5 | 416.5 | 391.2 | 390.1 | 226.4 |
| R_{wp}(%) | 11.12 | 2.75 | 13.13 | 3.59 | 4.19 |
| Rₑₓₚ(%) | 4.62 | 2.07 | 4.51 | 2.30 | 2.57 |
| GOF | 5.802 | 1.75 | 8.48 | 2.43 | 2.66 |

*C.S.: average crystallite size; R_{wp}: weighed profile R-factor; Rₑₓₚ: expected R-factor; GOF: goodness-of-fit; a₀: lattice parameter; U, W, V: peak parameters; FWHM: Full width at half maximum.

Bulk CoFe₂O₄ is known to be an inverse spinel, but its degree of inversion is affected by many factors such as the synthesis method [40-42], temperature [43], and particle size [41]. On the other hand, MnFe₂O₄ adopts a mixed spinel structure in which Mn atoms can be found in the T_{d} sites and Oₕ sites [44].

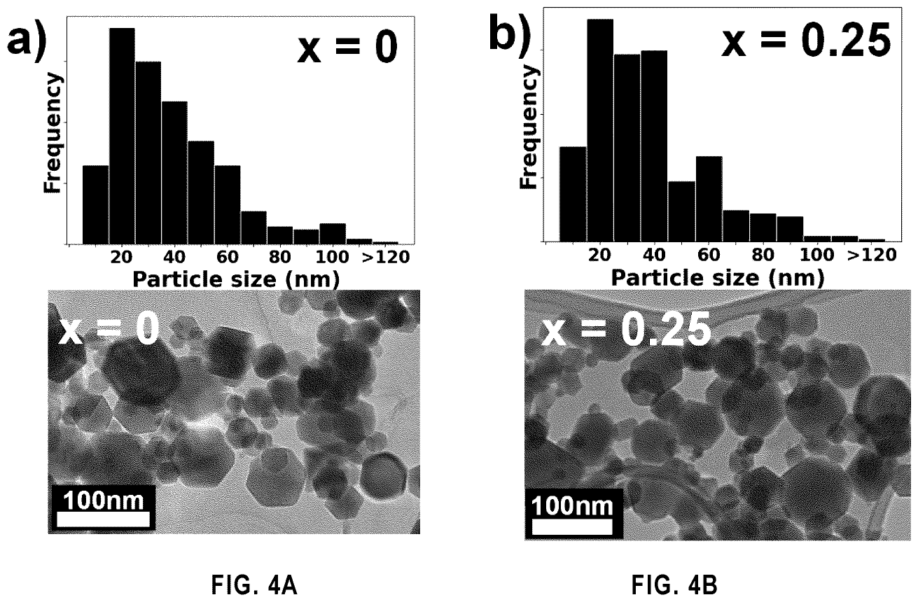

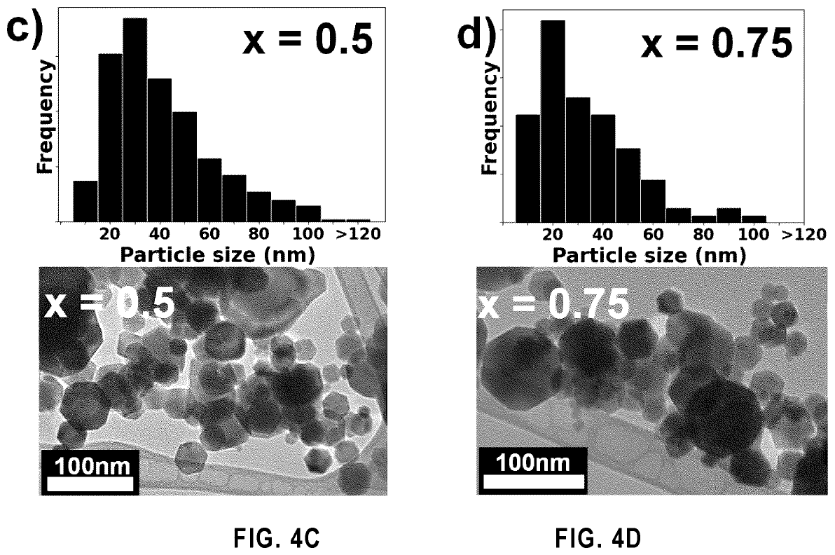

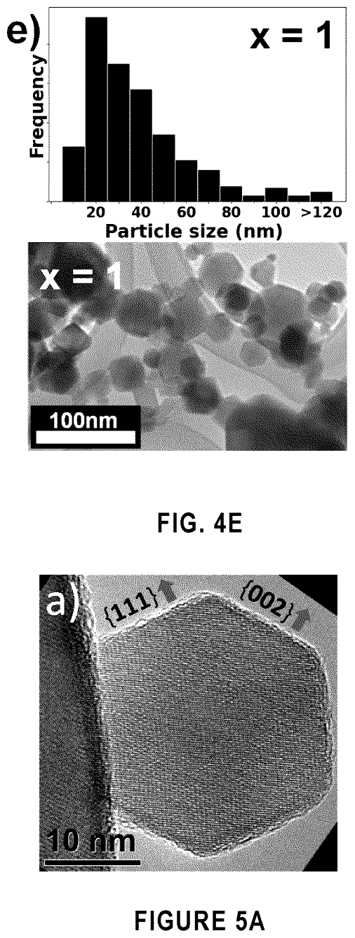

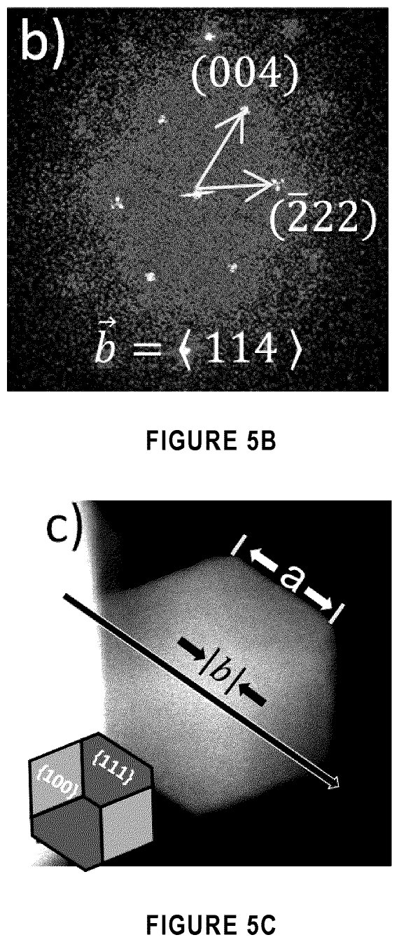

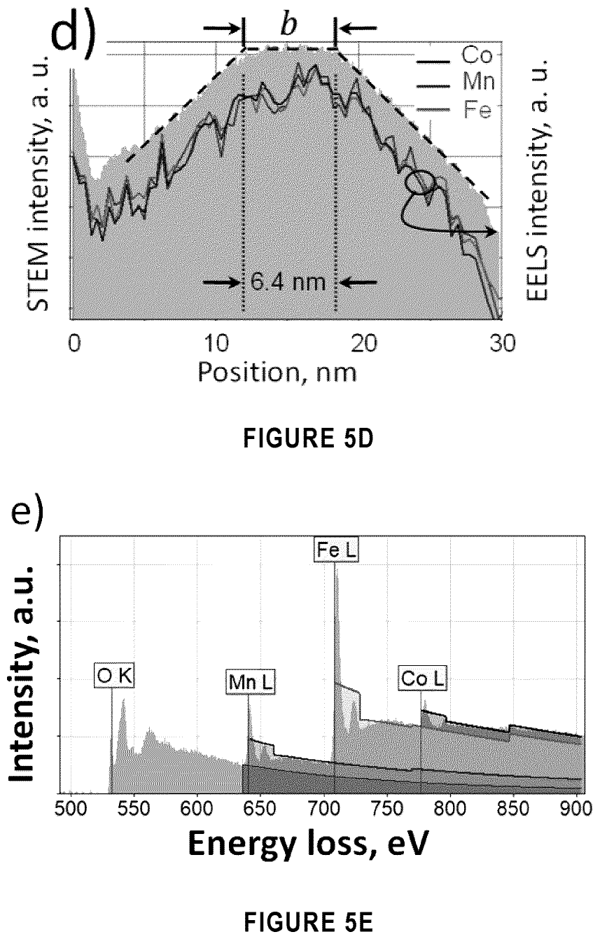

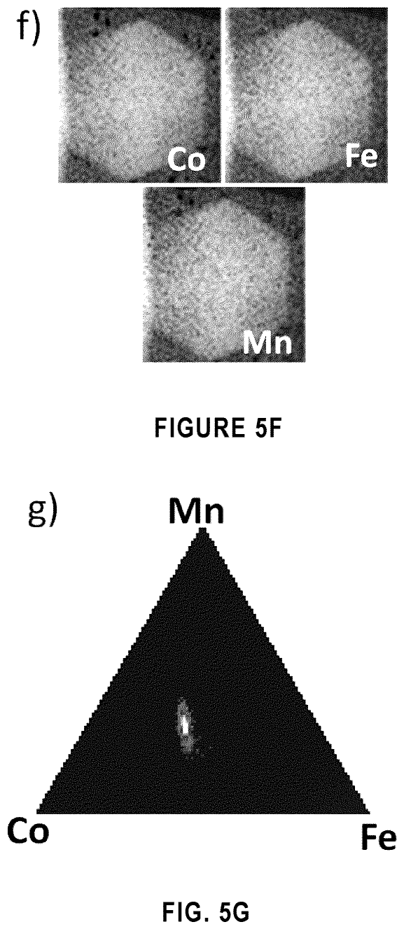

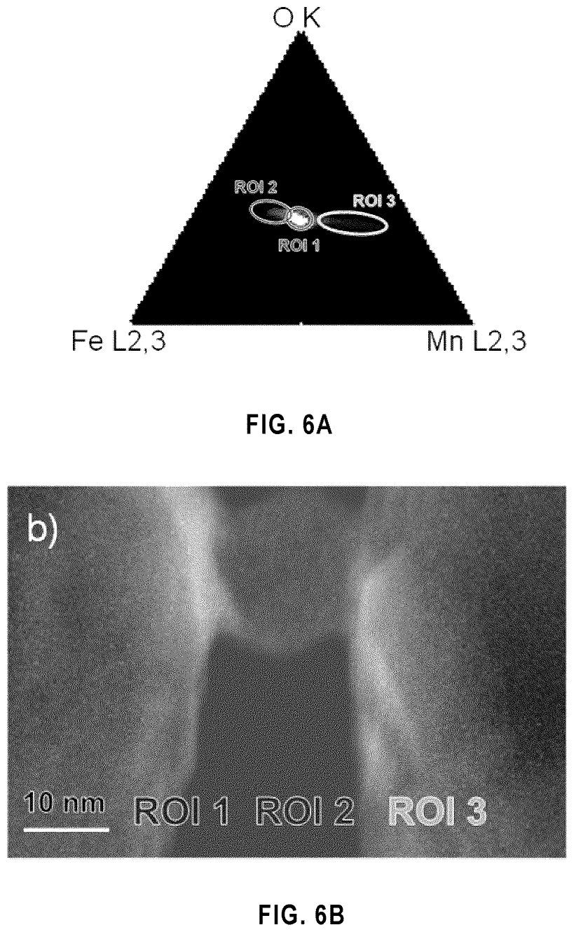

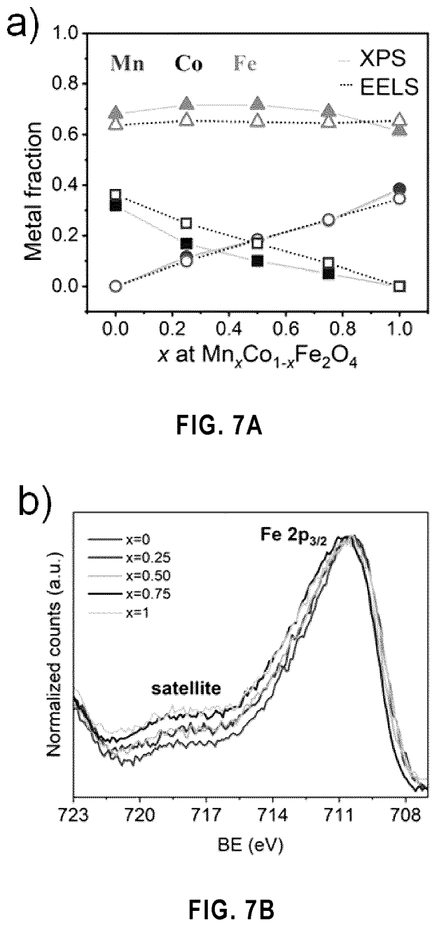

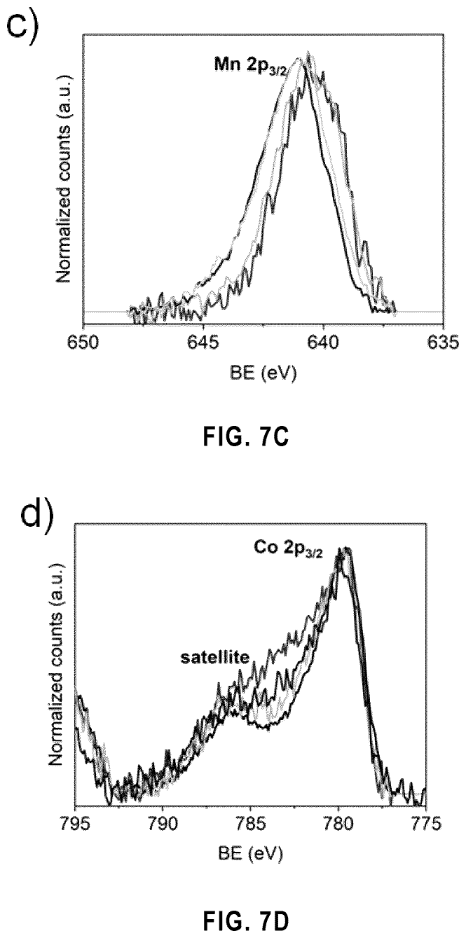

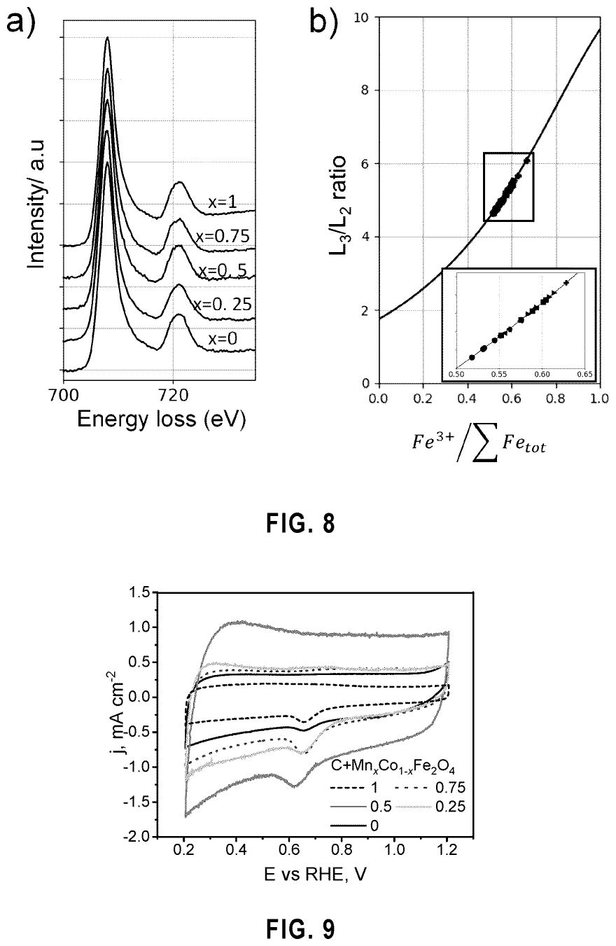

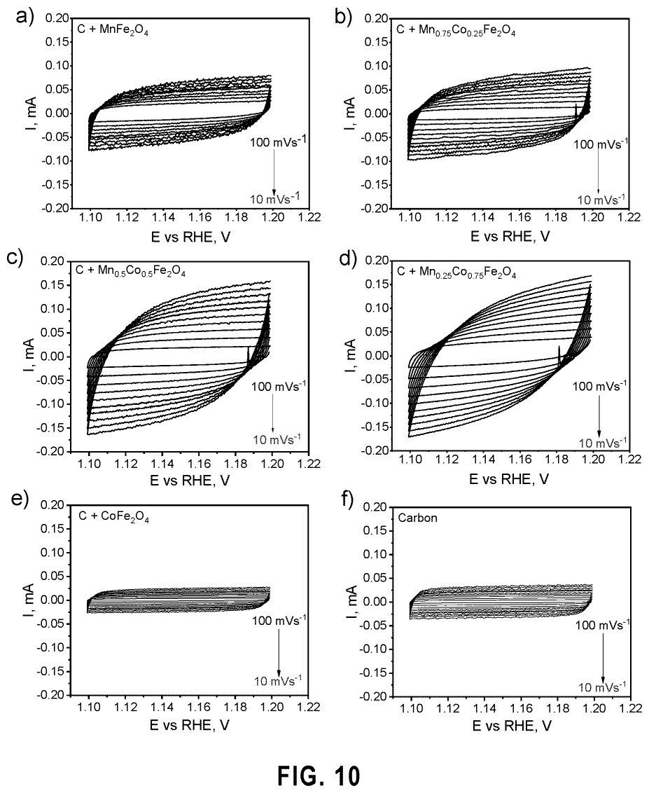

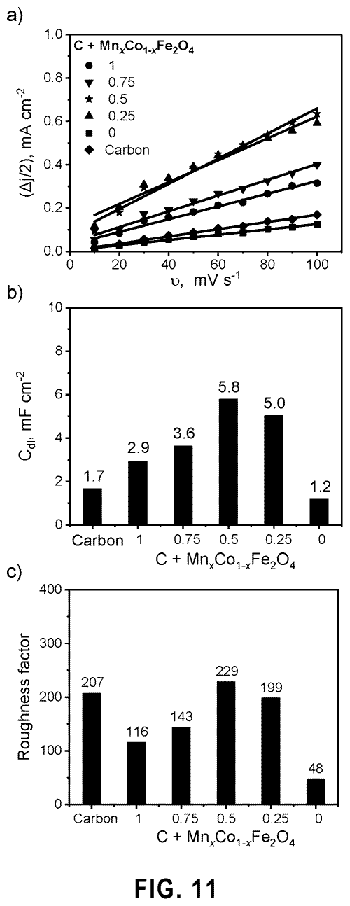

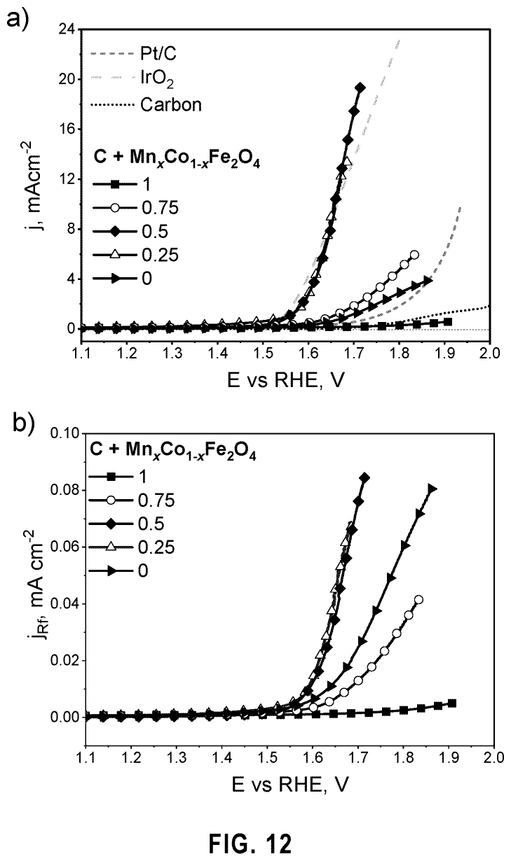

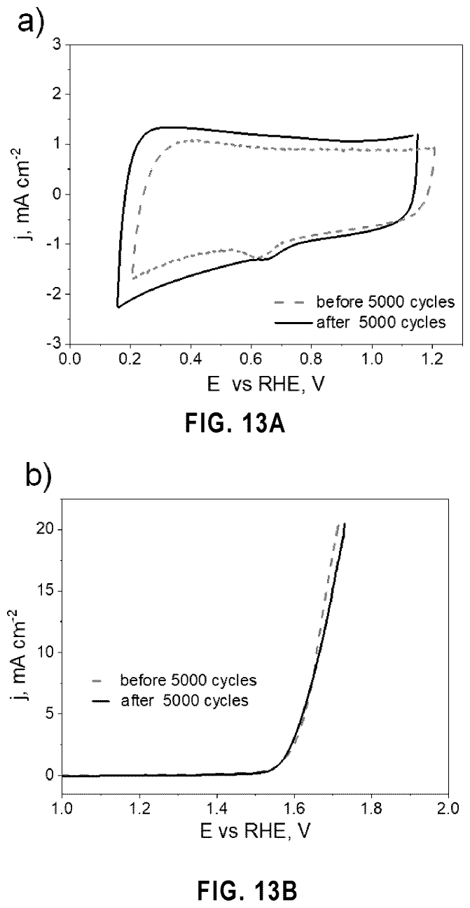

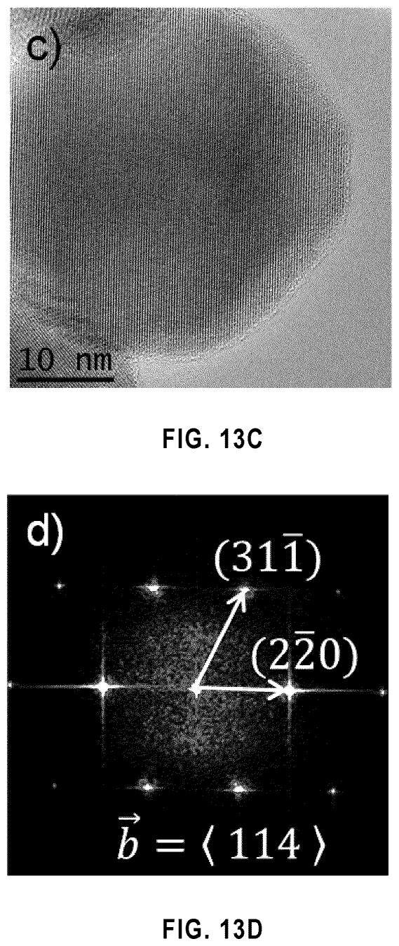

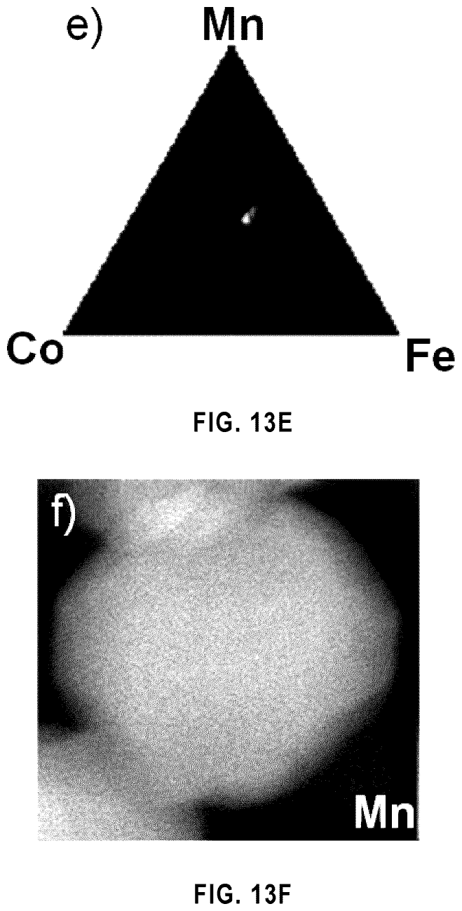

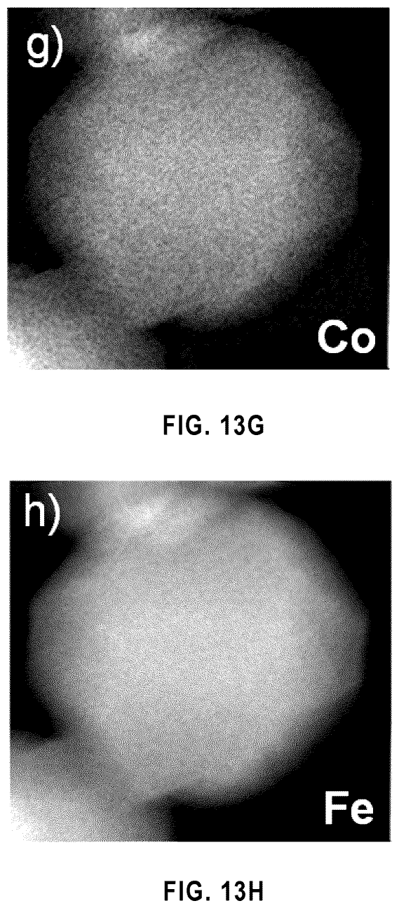

The well-defined facets of the nanocrystals are obvious from the bright-field TEM micrographs, as shown in FIG. 4a-e. The particle size ranges from 20 to 80 nm, with a 40 nm diameter median size and a distribution skewed towards lower size. The projections of the NPs are consistent with a shape of a bitruncated cube exposing squares and hexagons facets, respectively assigned to the {100} and {111} planes. The HR-TEM lattice image in FIG. 5a and corresponding diffractogram in FIG. 5b of a single NP taken from the sample with x=0.5 illustrates the assignation. From the lattice, it is determined that this particle is in the (110) zone axis and exposes the {100} (squares) and {111} (truncated triangles) facets. The sharpness of the facets and the general shape of the particle is further validated by the HAADF contrast, known to be proportional to the projected local thickness of the particles and to Zⁿ, with Z the atomic number and n~2. In the NP shown in FIG. 5, its HAADF contrast is consistent with a bitruncated cube (orientation shown in inset of FIG. 5c). An HAADF intensity line profile taken across the NP (FIG. 5d) in the [1̅10] direction confirms that the facets are sharp and flat. The contrast profile was also used to confirm the projected shape and to extract the precise geometrical parameters, such as the dimensions of the {111} truncated triangle facets, a and b. In this case, R, the {100}/{111} area facet ratio of that NP was found to be ~0.55. From multiple particle measurements in the samples, R was found to vary from ~0.64 to ~0.46 when x increases from 0 to 1. While the particles expose mainly the {100} and {111} facets, the existence of minor {110} facets intersecting {111} planes cannot be excluded.

The NPs bulk and surface composition were evaluated by EELS and XPS analysis. Using the standard-based quantification scheme [35], the composition of several particles for each sample was determined by EELS mapping. A typical background-subtracted spectrum is shown in FIG. 5e exhibiting the O K and Mn, Fe and Co L_{2,3} edges. The overall composition of NPs is consistent with that deduced from the Rietveld refined lattice constant for all compositions except for the sample with the MnFe₂O₄ (x=1).

As reported in Table 1 and Table 2, the elemental quantification obtained by XRD and EELS demonstrated a slight Fe deficiency compared to the nominal ones. For all compositions with x<1, the EELS elemental mapping confirmed the homogeneous elemental distribution down to the atomic level. In FIG. 5f the homogeneous spatial distribution of Mn (red), Fe (green) and Co (blue) EELS intensity across the projected volume of the NP with x=0.5 is shown. A line profile of the Mn, Fe and Co EELS intensities (color lines in FIG. 5e) taken across the [1̅10] direction of the same NP is consistent with the STEM projected intensity and does not reveal any preferential segregation. Plotting the EELS intensity trivariate histogram of the same particle (FIG. 5g) confirms a tight elemental distribution centered around the Mn:Co:Fe:=1:1:2 atomic ratio. By contrast, MnFe₂O₄ NPs exhibit obvious Mn segregation at the surface and between them (FIG. 6 and Table 3) that could be ascribed to the second minor phase detected in XRD.

TABLE 2
Elemental NPs composition (at. %) determined by EELS
quantification in MnₓCo₁₋ₓFe₂O₄. The composition is
obtained by multiplying the elemental fraction by 7, the
number of elements in MnₓCo₁₋ₓFe₂O₄

| Element fraction, at % | | | | | |
|---|---|---|---|---|---|
| x | O | Fe | Co | Mn | Composition |
| 0 | 57.6 | 27.0 | 15.3 | 0 | Co_{1.07}Fe_{1.89}O_{4.03} |
| 0.25 | 56.9 | 28.4 | 10.8 | 4.2 | Mn_{0.30}Co_{0.75}Fe_{1.98}O_{3.98} |
| 0.50 | 57.1 | 27.9 | 7.2 | 7.8 | Mn_{0.55}Co_{0.51}Fe_{1.95}O₄ |
| 0.75 | 57.2 | 27.7 | 3.9 | 11.3 | Mn_{0.79}Co_{0.27}Fe_{1.94}O₄ |
| 1 | 57.1 | 28.1 | 0 | 14.9 | Mn_{1.04}Fe_{1.97}O_{3.99}* |

*Two phases were identified by XRD see Table 1.

TABLE 3
EELS elemental quantification of regions of
interests (ROIs) identified in (FIG. 6a)

| | Element | | |
|---|---|---|---|
| ROI | O | Fe | Mn |
| ROI 1 | 56.2 | 27.0 | 16.8 |
| ROI 2 | 57.1 | 28.1 | 14.5 |
| ROI 3 | 55.5 | 16.7 | 27.7 |
| MnFe₂O₄ | 57.1 | 28.6 | 14.3 |

For chemical surface analysis, survey and high-resolution photoemission spectra of Fe 2p, Co 2p and Mn 2p were recorded. Fe, Co and Mn elemental quantification were done from the integration of the 2p peaks (see experimental section). Similar trends and an excellent agreement between the metal compositions were obtained by EELS and XPS, as illustrated in FIG. 7a. These results emphasize the advantages of the solution spray plasma synthesis to prepare uniform spinels nanoparticles of controlled composition.

The valence of the cations was probed by EELS and XPS from the analysis of the core level spectra recorded by these techniques. In the case of the core loss EEL spectra this was done through the inspection of the near-edge structure (ELNES) of the L_{2,3} edges. These are characterized by two so-called “white lines” peaks associated to the dipole transitions to unoccupied d states. The white line onset, L₃ to L₂ ratio and respective width provides insight on the electronic state of the element. A standardized procedure for measuring the valence of Fe in minerals using the L₃ to L₂ intensity ratio was proposed by van Aken et al. [45]. Using this methodology, it was concluded that the NPs contain both Fe²⁺ and Fe³⁺ species, and that the Fe⁺³/ΣFe increased with x from 0.53 to 0.60 (FIG. 8b).

The XPS Fe 2p spectra are composed of two main peaks centered between 710.3 and 710.8 eV (2p_{3/2}) and at ~724.3 eV (2p_{1/2}), with their respective broad satellites feature located at higher biding energies. FIG. 7b presents the Fe 2p_{3/2} spectra recorded for all samples after background subtraction and normalization. According to the literature [46-48], the characteristic binding energy values for Fe²⁺ and Fe³⁺ species in spinel are ~710 eV and 710.7 eV, respectively, with their satellite peaks found at binding energies 6 and 8 eV higher. Binding energy values close to 710.5 eV and between 713.0 and 713.3 eV were also reported for Fe³⁺ ions in the Oₕ sites and in Tₕ sites, respectively [49]. Thus, and as expected, XPS analysis agree with the presence of both Fe²⁺ and Fe³⁺. The partial

replacement of Co by Mn could cause a slight broadening and shift of the position of the main peak to higher binding energy, consistent with a partial conversion of Fe²⁺ into Fe³⁺.

The identification of the Mn oxidation states in the spinels revealed to be quite challenging. Van Aken's universal calibration curve for EELS spectra exists for Fe but not for Mn. In addition, the L₃/L₂ ratio and FWHM for various simple Mn oxides are available but do not consider the coexistence of other mixed valence metals in the lattice. Insight on the Mn oxidation state was rather obtained with XPS. The collected Mn 2p spectra show a shift of the 2p_{3/2} peak maximum from ~640.4 eV to ~641.0 eV with the increase of x, FIG. 7c. Binding energy values close to 640 eV were reported for Mn²⁺ ions in MnFe₂O_{4 [47, 51}] and between 640.0 and 640.5 eV in MnFeₓCr₂₋ₓO₄ [46]. However, the same study reported binding energy values of Mn²⁺ ions in MnₓFe₁₋ₓCr₂O₄ in the range 641.0-641.3 eV [46]. Thus, XPS analysis confirms the presence of Mn²⁺ ions but the presence of Mn³⁺ ions (641.7 eV in CoMn₂O₄ [51]) cannot be excluded. In any case, the shift in the binding energy values with x is an indication that the chemical environment of Mn varies along the series. These observations agree with a previous work from Hou et al. [52] where DFT calculations and magnetic moment measurements showed that Mn³⁺ ions prefer to substitute Co²⁺ ions in the Oₕ sites when the Mn content is low (0<x≤0.25) with the rest of the Mn ions filling the T_{d} sites with +2 oxidation state, for x≥0.375. At high Mn content, the Fe²⁺ ions are converted to Fe³⁺ ions for charge balance.

It was not possible to deduce the valence from EELS L_{2,3} edge of Co because of the weak signal-to-noise ratio which decreases with the energy loss. But the Co 2p XPS spectra FIG. 7d are rich in information. The spectra consist of two main peaks with their maxima located between 779.5 and 779.9 eV (Co 2p_{3/2}), 795.1 and 795.5 eV (Co 2p_{1/2}), and their respective satellite peaks. According to the literature on cobalt spinel oxides, the satellite peaks should indicate the presence of high spin Co(II) species. According to previous work, Co²⁺ ions that occupy the Oₕ and T_{d} positions should exhibit peaks at ~780 eV and ~782.5 eV, respectively. On the other hand, Co³⁺ ions in the Oₕ position should translate to a peak at ~781 eV [46-48, 53]. The 2p_{3/2} spectra are compared in FIG. 7d. The shape of the main peak indicates the presence of Co²⁺ and Co³⁺ ions in the Oₕ sites in all samples. A third peak located at higher binding energy (~783 eV) appears when Co is partially replaced by Mn, indicating the population of the Tₕ sites with Co²⁺ ions. The variations in the cationic distribution are consistent with the highest preference of Mn³⁺ ions for the Oₕ sites (−95.4 kJ·mol⁻¹) compared to Co²⁺ ions (−31 kJ·mol⁻¹), and highest crystal field stable energy for the Td field of Co²⁺ ions (−61.9 kJ·mol⁻¹) compared to Mn²⁺ ions (−61.9 kJ·mol⁻¹) [10].

Before OER studies, all carbon+mixed spinel ferrites composite electrodes were first conditioned by cyclic voltammetry in the potential window between 0.2 and 1.2 V vs RHE at a sweep rate of 50 mV s⁻¹ for 40 cycles. Almost featureless cyclic voltammograms with the characteristic shape of the double-layer charge-discharge were recorded in all cases, as shown in FIG. 9. The cathodic peak at 0.6 V vs RHE is related to the reduction of oxygen trapped in the catalyst layers. Afterwards, the double-layer capacitance (C_{dl}) of the electrodes/electrolyte interface was determined by cyclic voltammetry in a narrow potential window (1.10 to 1.20 V vs RHE) at different scan rates (see experimental section, FIG. 10 and FIG. 11a). As shown in FIG. 11b, the average C_{dl} values vary between 1.2 mF cm⁻² (x=0) and 5.8 mF cm⁻² (x=0.5) and show a bell-shape dependence with the Mn content. Since the particle sizes and specific surface area of the nanoparticles is practically the same for all compositions, variations in the C_{dl} values can be explained only by variations of the surface composition and/or electrical conductivity of the spinel ferrites. As discussed, the incorporation of Mn in the spinel structure leads to variations in the valence of Fe, Co and Mn ions with the formation of Fe²⁺/Fe³⁺,

$${Co}_{Td}^{2 +} / {Co}_{Oh}^{3 +} and {Mn}_{Td}^{2 +} / {Mn}_{Oh}^{3 +}$$

redox pairs which could enhance the electronic conductivity of the nanoparticles⁵⁵.

The activity of the spinel oxide composite electrodes toward the OER in 0.1 M KOH was thus evaluated. As shown in FIG. 12a, only the C+Mn_{0.25}Co_{0.75}Fe₂O₄ and C+Mn_{0.5}Co_{0.5}Fe₂O₄ composite electrodes showed an appreciable oxygen evolution current and comparable to that of IrO₂/C. A current density of 10 mA cm⁻² (the most widely accepted benchmark to compare the OER performance of electrodes) is achieved at 1.65 V vs RHE for the three electrodes. At the same time, the onset potential of these two spinel oxides composite electrodes (1.56 V, j=1.0 mA cm⁻²) is very close to that of the IrO₂/C electrode (1.54 V, j=1.0 mA cm⁻²). As expected, the CoFe₂O₄ prepared in this work shows much lower activity for OER compared to that reported for CoFe₂O₄ with particle sizes below 6 nm [31]. Besides, the authors reported Co²⁺ ions on both T_{d} and Oₕ sites [31], whereas in the present case, the Co ions of pristine CoFe₂O₄ seem to occupy mostly the Oₕ sites. The presence of two phases and the segregation of Mn to the surface of the NPs might account for the low OER activity of the MnFe₂O₄ composite electrode.

To get additional insights on the effect of the partial replacement of Co by Mn on the intrinsic activity of the ferrites, the OER polarization curves were normalized to the roughness factor of the respective composite electrode (FIG. 12b). By doing so, the contribution of the surface area of the composite electrodes to the OER activity is eliminated. As illustrated in FIG. 12b, the intrinsic activity increases from x=0 to x=0.5, and then it decreases for x>0.5. As previously mentioned, the incorporation of Mn in the spinel structure leads to the formation of

$${Co}_{Td}^{2 +} / {Co}_{Oh}^{3 +}$$

couple in the spinel structure. The Co²⁺ ions on the T_{d} sites could be converted Co³⁺ ions in Oₕ coordination during the surface reconstruction at high overpotentials thus favoring the OER [19, 20, 54].

A comparison of the overall OER activity of the electrodes derived from the Mn_{0.25}Co_{0.75}Fe₂O₄ and Mn_{0.5}Co_{0.5}Fe₂O₄ spinel ferrites is reported in Table 4. We reported the most common figure of merit used to compare catalyst activity is the electrode potential (vs. reversible hydrogen electrode potential, RHE) measured at 10 mA·cm² current (geometric electrode area). We chose to report measured OER activity with a fixed electrolyte concentration (0.1 or 1.0 M KOH) and current density (1, 5 or 10 mA·cm⁻²). The performance of Co_{0.5}Mn_{0.5}Fe₂O₄ is appreciable given its low specific surface. This is likely due to selective active crystal planes of these truncated spinel nanocrystals that are selectively exposing active facets. The observed shape approaches the equilibrium (Wulff) shape typical to face-centered cubic structures. The possibility of forming these NPs with faceted shape and morphology is directly related to their thermal history in the plasma reactor. Similar shapes are also observed in other process that offer fast quench rates such as solution-spray pyrolysis or laser ablation.

TABLE 4
OER catalyst performance - comparison with data reported in the literature

| | | | | | E vs | |
|---|---|---|---|---|---|---|
| | Particle | SSA, | [KOH], | j, | RHE, | |
| Catalyst | size, nm | m²g⁻¹ | M | mAcm⁻² | V | Ref. |
| Co_{0.5}Mn_{0.5}Fe₂O₄ | | 22 | 0.1 | 10 | 1.65 | This work |
| CoV_{1.5}Fe_{0.5}O₄ | <10 | n.a. | 1 | 10 | 1.54 | 56 |
| Co_{0.5}Ni_{0.5}Fe₂O₄ | <10 | n.a. | 1 | 10 | 1.56 | 57 |
| CoFe₂O₄ | 8-16 | 83 | 0.1 | 10 | 1.79 | 58 |
| CoFe₂O₄ amorphous | 2-8 | 127 | 0.1 | 10 | 1.72 | 58 |
| CoFe₂O₄ nanospheres | 400-1000 | 103 | 0.1 | 10 | 1.68 | 59 |
| CoFe₂O₄ nanospheres | 400-1000 | 75 | 0.1 | 10 | 1.74 | 59 |
| MFe₂O₄ (M = Co, Ni, Cu, Fe) | l = 12000 | 60 | 0.1 | 5 | 1.64-1.74 | 60 |
| nanofibers | w = 150 | | | | | |
| CoFe₂O₄ nanospheres @rGO | 70 | n.a. | 0.1 | 10 | 1.73 | 61 |
| MnFe₂O₄ @carbon black | 6.5 | n.a. | 0.1 | 10 | 1.75 | 62 |
| AlMn₂O₄ | n.a. | n.a. | 0.1 | 1 | 1.8 | 63 |
| Ni₄₅Fe₅₅ @carbon black | n.a. | 182 | 0.1 | 10 | 1.5 | 64 |

Finally, another important figure of merit of a catalyst is its endurance to potential cycling. Thus, the C+Mn_{0.5}Co_{0.5}Fe₂O₄ composite electrode, which showed the best OER performances, was subjected to 5,000 cycles between 0.908 and 0.408 V vs RHE in O₂-saturated 0.1 M KOH electrolyte. To effectively assess the electrocatalyst's stability and structural characteristics, the spinel oxide powder only (without carbon) was dispersed in isopropyl alcohol and deposited on the RDE. Afterwards, the oxide powder was mixed with carbon Vulcan and tested again for OER. As included in FIGS. 13a and b, the shape of the cyclic voltammograms and the electrocatalytic activity of the composite electrodes for the OER were not affected, demonstrating the remarkable stability of this spinel oxide to extensive cycling. Furthermore, the structural characteristics and composition of the spinel oxide remain similar to that of the as-prepared sample (Table 5). FIGS. 13c and d shows that the crystalline nature in the bulk of the NP and on its surface are well distributed and retain their initial {100} and {111} facets. Furthermore, EELS mapping of individual NPs (FIG. 13d) shows that the NPs retain their uniform distribution homogeneity with no sign of surface segregation which is confirmed by plotting the EELS intensity trivariate histogram (FIG. 13e) that show the same tight elemental distribution centered around the Mn:Co:Fe:=1:1:2 atomic ratio as before cycling.

TABLE 5
Elemental composition (at. %) according to EELS quantification

| | Element | | | | |
|---|---|---|---|---|---|
| | Fe | O | Co | Mn | Composition |
| Initial | 57.12 | 27.86 | 7.22 | 7.79 | Mn_{0.55}Co_{0.51}Fe_{1.95}O₄ |
| After 5000 cycles | 58.02 | 27.72 | 7.51 | 6.71 | Mn_{0.47}Co_{0.53}Fe_{1.94}O_{4.06} |

### CONCLUSION

Plasma induction technique was used as a cost-efficient method to obtain sub-100 nm crystalline nanoparticles of different mixed spinel oxides MnₓCo₁₋ₓFe₂O₄ (0≤x≤1). The oxide nanoparticles were found to have {100} and {111} facets exposed, with a {100}/{111} facet surface ratio of 0.55. The spinel oxides were mixed with Vulcan Carbon to explore their electrocatalytic activity towards OER in an alkaline medium. Tuning the composition of both Mn and Co in the spinel ferrite induced variations in the oxidation states of the metal cations, namely the formation of

$${Co}_{Td}^{2 +} / {Co}_{Oh}^{3 +}$$

couple, thus conferring a competitive and robust performance towards OER. In addition to the high electrocatalytic activity, the Mn_{0.5}Co_{0.5}Fe₂O₄ demonstrated superior tolerance to extensive cycling, with no variations of its structure and morphology. This faceted morphology is a consequence of the thermal history typical to the thermal plasma reactors. We believe that this mixed spinel ferrite is a promising alternative catalyst to replace commercial IrO₂/C catalysts and holds great potential in applications such as reversible fuel cells, metal-air batteries and electrolysers operating under alkaline conditions.

The scope of the claims should not be limited by the preferred embodiments set forth in the examples, but should be given the broadest interpretation consistent with the description as a whole.

### REFERENCES

The present description refers to a number of documents, the content of which is herein incorporated by reference in their entirety. These documents include, but are not limited to, the following:
[1] H. Zhu, S. Zhang, Y. X. Huang, L. Wu, S. Sun, Monodisperse M(x)Fe(3−x)O4 (M=Fe, Cu, Co, Mn) nanoparticles and their electrocatalysis for oxygen reduction reaction, Nano letters, 13 (2013) 2947-2951.
[2] L. Dai, Y. Xue, L. Qu, H.-J. Choi, J.-B. Baek, Metal-free catalysts for oxygen reduction reaction, Chemical reviews, 115 (2015) 4823-4892.
[3] Y.-H. Fang, Z.-P. Liu, Tafel Kinetics of Electrocatalytic Reactions: From Experiment to First-Principles, ACS Catalysis, 4 (2014) 4364-4376.
[4] E. Pizzutilo, J. Knossalla, S. Geiger, J. P. Grote, G. Polymeros, C. Baldizzone, S. Mezzavilla, M. Ledendecker, A. Mingers, S. Cherevko, The Space Confinement Approach Using Hollow Graphitic Spheres to Unveil Activity and Stability of Pt—Co Nanocatalysts for PEMFC, Advanced Energy Materials, 7 (2017) 1700835.
[5] R. Kötz, H. Lewerenz, S. Stucki, XPS studies of oxygen evolution on Ru and RuO₂ anodes, Journal of The Electrochemical Society, 130 (1983) 825-829.
[6] E. Antolini, Iridium as catalyst and cocatalyst for oxygen evolution/reduction in acidic polymer electrolyte membrane electrolyzers and fuel cells, Acs Catalysis, 4 (2014) 1426-1440.
[7] X. Ge, A. Sumboja, D. Wuu, T. An, B. Li, F. W. T. Goh, T. S. A. Hor, Y. Zong, Z. Liu, Oxygen Reduction in Alkaline Media: From Mechanisms to Recent Advances of Catalysts, ACS Catalysis, 5 (2015) 4643-4667.
[8] H. Gao, S. Liu, Y. Li, E. Conte, Y. Cao, A Critical Review of Spinel Structured Iron Cobalt Oxides Based Materials for Electrochemical Energy Storage and Conversion, Energies, 10 (2017).
[9] F. Cheng, J. Shen, B. Peng, Y. Pan, Z. Tao, J. Chen, Rapid room-temperature synthesis of nanocrystalline spinels as oxygen reduction and evolution electrocatalysts, Nature chemistry, 3 (2011) 79-84.
[10] Q. Zhao, Z. Yan, C. Chen, J. Chen, Spinels: controlled preparation, oxygen reduction/evolution reaction application, and beyond, Chemical reviews, 117 (2017) 10121-10211.
[11] C. Li, X. Han, F. Cheng, Y. Hu, C. Chen, J. Chen, Phase and composition controllable synthesis of cobalt manganese spinel nanoparticles towards efficient oxygen electrocatalysis, Nature communications, 6 (2015) 7345.
[12] J. B. Goodenough, Theory of the role of covalence in the perovskite-type manganites [La, M (II)] Mn O 3, Physical Review, 100 (1955) 564.
[13] W. R. Barros, J. R. Steter, M. R. Lanza, A. C. Tavares, Catalytic activity of Fe3−xCuxO4 (0≤x≤0.25) nanoparticles for the degradation of Amaranth food dye by heterogeneous electro-Fenton process, Applied Catalysis B: Environmental, 180 (2016) 434-441.
[14] E. Rios, J.-L. Gautier, G. Poillerat, P. Chartier, Mixed valency spinel oxides of transition metals and electrocatalysis: case of the MnxCo3−xO4 system, Electrochimica Acta, 44 (1998) 1491-1497.
[15] I. Abidat, N. Bouchenafa-Saib, A. Habrioux, C. Comminges, C. Canaff, J. Rousseau, T. Napporn, D. Dambournet, O. Borkiewicz, K. Kokoh, Electrochemically induced surface modifications of mesoporous spinels (Co 3 O 4−δ, MnCo 2 O 4−δ, NiCo 2 O 4−δ) as the origin of the OER activity and stability in alkaline medium, Journal of Materials Chemistry A, 3 (2015) 17433-17444.
[16] Y. Liang, H. Wang, J. Zhou, Y. Li, J. Wang, T. Regier, H. Dai, Covalent hybrid of spinel manganese-cobalt oxide and graphene as advanced oxygen reduction electrocatalysts, Journal of the American Chemical Society, 134 (2012) 3517-3523.
[117] Y. Zhou, S. Sun, C. Wei, Y. Sun, P. Xi, Z. Feng, Z. J. Xu, Significance of engineering the octahedral units to promote the oxygen evolution reaction of spinel oxides, Advanced materials, 31 (2019) 1902509.
[18] Y. Sun, H. Liao, J. Wang, B. Chen, S. Sun, S. J. H. Ong, S. Xi, C. Diao, Y. Du, J.-O. Wang, Covalency competition dominates the water oxidation structure-activity relationship on spinel oxides, Nature Catalysis, 3 (2020) 554-563.
[19] A. Bergmann, E. Martinez-Moreno, D. Teschner, P. Chernev, M. Gliech, J. F. De Araújo, T. Reier, H. Dau, P. Strasser, Reversible amorphization and the catalytically active state of crystalline Co 3 O 4 during oxygen evolution, Nature communications, 6 (2015) 1-9.
[20] H.-Y. Wang, S.-F. Hung, H.-Y. Chen, T.-S. Chan, H. M. Chen, B. Liu, In operando identification of geometrical-site-dependent water oxidation activity of spinel Co3O4, Journal of the American Chemical Society, 138 (2016) 36-39.
[21] F. Zasada, J. Grybos, P. Indyka, W. Piskorz, J. Kaczmarczyk, Z. Sojka, Surface Structure and Morphology of M [COM′] O4 (M=Mg, Zn, Fe, Co and M′=Ni, Al, Mn, Co) Spinel NanocrystalsI DFT+U and TEM Screening Investigations, The Journal of Physical Chemistry C, 118 (2014) 19085-19097.
[22] E. Agouriane, B. Rabi, A. Essoumhi, A. Razouk, M. Sahlaoui, B. Costa, M. Sajieddine, Structural and magnetic properties of CuFe2O4 ferrite nanoparticles synthesized by co-precipitation, J. Mater. Environ. Sci, 7 (2016) 4116-4120.
[23] P. Lavela, J. Tirado, CoFe₂O₄ and NiFe2O4 synthesized by sol-gel procedures for their use as anode materials for Li ion batteries, Journal of power sources, 172 (2007) 379-387.
[24] E. Wetterskog, M. Agthe, A. Mayence, J. Grins, D. Wang, S. Rana, A. Ahniyaz, G. Salazar-Alvarez, L. Bergström, Precise control over shape and size of iron oxide nanocrystals suitable for assembly into ordered particle arrays, Science and Technology of Advanced Materials, 15 (2014) 055010.
[25] W. J. Stark, P. R. Stoessel, W. Wohlleben, A. Hafner, Industrial applications of nanoparticles, Chemical Society reviews, 44 (2015) 5793-5805.
[26] S. Bastien, N. Braidy, Controlled synthesis of nickel ferrite nanocrystals with tunable properties using a novel induction thermal plasma method, Journal of Applied Physics, 114 (2013) 214304.
[27] T. Ishizaki, S. Chiba, Y. Kaneko, G. Panomsuwan, Electrocatalytic activity for the oxygen reduction reaction of oxygen-containing nanocarbon synthesized by solution plasma, Journal of Materials Chemistry A, 2 (2014) 10589-10598.
[28] A. Y. Li, N. Dumaresq, A. Segalla, N. Braidy, A. Moores, Plasma-Made (Ni0. 5Cu0. 5) Fe₂O₄ Nanoparticles for Alcohol Amination under Microwave Heating, ChemCatChem, (2019).
[29] S. Son, R. Swaminathan, M. McHenry, Structure and magnetic properties of rf thermally plasma synthesized Mn and Mn—Zn ferrite nanoparticles, Journal of applied physics, 93 (2003) 7495-7497.
[30] E. V. Shunko, D. E. Stevenson, V. S. Belkin, Inductively Coupling Plasma Reactor With Plasma Electron Energy Controllable in the Range From ${\sim}{6} $ to ${\sim}{\rm 100}~{\rm eV} $, IEEE Transactions on Plasma Science, 42 (2014) 774-785.
[31] K. Chakrapani, G. Bendt, H. Hajiyani, I. Schwarzrock, T. Lunkenbein, S. Salamon, J. Landers, H. Wende, R. Schlögl, R. Pentcheva, Role of composition and size of cobalt ferrite nanocrystals in the oxygen evolution reaction, ChemCatChem, 9 (2017) 2988-2995.
[32] M. I. Godinho, M. A. Catarino, M. da Silva Pereira, M. Mendonça, F. Costa, Effect of the partial replacement of Fe by Ni and/or Mn on the electrocatalytic activity for oxygen evolution of the CoFe₂O₄ spinel oxide electrode, Electrochimica acta, 47 (2002) 4307-4314.
[33] L. Jia, F. Gitzhofer, Nano-particle sizing in a thermal plasma synthesis reactor, Plasma Chemistry and Plasma Processing, 29 (2009) 497.
[34] S. Bastien, C. Ricolleau, N. Braidy, Nano-Architecture of Facetted NiFe 2 O 4/(Ni, Fe) O Particles Produced by Induction Plasma, Plasma Chemistry and Plasma Processing, 36 (2016) 1349-1362.
[35] R. F. Egerton, Electron energy-loss spectroscopy in the electron microscope, Springer Science & Business Media2011.
[36] S. Trasatti, O. Petrii, Real surface area measurements in electrochemistry, Pure and applied chemistry, 63 (1991) 711-734.
[37] M. De Koninck, S.-C. Poirier, B. Marsan, Cu x Co3−x O4 Used as Bifunctional Electrocatalyst: Physicochemical properties and electrochemical characterization for the oxygen evolution reaction, Journal of The Electrochemical Society, 153 (2006) A2103.
[38] S. Levine, A. Smith, Theory of the differential capacity of the oxide/aqueous electrolyte interface, Discussions of the Faraday Society, 52 (1971) 290-301.
[39] H. Ji, X. Zhao, Z. Qiao, J. Jung, Y. Zhu, Y. Lu, L. L. Zhang, A. H. MacDonald, R. S. Ruoff, Capacitance of carbon-based electrical double-layer capacitors, Nature communications, 5 (2014) 1-7.
[40] G. Sawatzky, F. Van Der Woude, A. Morrish, Cation distributions in octahedral and tetrahedral sites of the ferrimagnetic spinel CoFe₂O₄, Journal of Applied Physics, 39 (1968) 1204-1205.
[41] R. Safi, A. Ghasemi, R. Shoja-Razavi, E. Ghasemi, T. Sodaee, Rietveld structure refinement, cations distribution and magnetic features of CoFe₂O₄ nanoparticles synthesized by co-precipitation, hydrothermal, and combustion methods, Ceramics International, 42 (2016) 6375-6382.
[42] T. Prabhakaran, R. Mangalaraja, J. C. Denardin, J. A. Jiménez, The effect of calcination temperature on the structural and magnetic properties of co-precipitated CoFe₂O₄ nanoparticles, Journal of Alloys and Compounds, 716 (2017) 171-183.
[43] P. Chandramohan, M. Srinivasan, S. Velmurugan, S. Narasimhan, Cation distribution and particle size effect on Raman spectrum of CoFe₂O₄, Journal of Solid State Chemistry, 184 (2011) 89-96.
[44] J. M. Hastings, L. M. Corliss, Neutron diffraction study of manganese ferrite, Physical Review, 104 (1956) 328.
[45] P. Van Aken, B. Liebscher, Quantification of ferrous/ferric ratios in minerals: new evaluation schemes of Fe L 23 electron energy-loss near-edge spectra, Physics and Chemistry of Minerals, 29 (2002) 188-200.
[46] G. Allen, S. Harris, J. Jutson, J. Dyke, A study of a number of mixed transition metal oxide spinels using X-ray photoelectron spectroscopy, Applied Surface Science, 37 (1989) 111-134.
[47] S. Diodati, L. Pandolfo, A. Caneschi, S. Gialanella, S. Gross, Green and low temperature synthesis of nanocrystalline transition metal ferrites by simple wet chemistry routes, Nano Research, 7 (2014) 1027-1042.
[48] J. Yang, H. Liu, W. N. Martens, R. L. Frost, Synthesis and characterization of cobalt hydroxide, cobalt oxyhydroxide, and cobalt oxide nanodiscs, The Journal of Physical Chemistry C, 114 (2010) 111-119.
[49] L. Zhang, X. Zhao, C. Niu, N. Tang, H. Guo, X. Wen, C. Liang, G. Zeng, Enhanced activation of peroxymonosulfate by magnetic Co3MnFeO6 nanoparticles for removal of carbamazepine: Efficiency, synergetic mechanism and stability, Chemical Engineering Journal, 362 (2019) 851-864.
[50] L. Yedra, E. Xuriguera, M. Estrader, A. López-Ortega, M. D. Baró, J. Nogués, M. Roldan, M. Varela, S. Estrade, F. Peiró, Oxide wizard: An EELS application to characterize the white lines of transition metal edges, Microscopy and Microanalysis, 20 (2014) 698-705.
[51] T. Herranz, S. Rojas, M. Ojeda, F. Pérez-Alonso, P. Terreros, K. Pirota, J. Fierro, Synthesis, structural features, and reactivity of Fe—Mn mixed oxides prepared by microemulsion, Chemistry of Materials, 18 (2006) 2364-2375.
[52] Y. Hou, X. Yan, Y. Huang, S. Zheng, S. Hou, Y. Ouyang, Structural, electronic and magnetic properties of manganese substituted CoFe₂O₄: a first-principles study, Journal of Magnetism and Magnetic Materials, 495 (2020) 165862.
[53] Z. Zhou, Y. Zhang, Z. Wang, W. Wei, W. Tang, J. Shi, R. Xiong, Electronic structure studies of the spinel CoFe₂O₄ by X-ray photoelectron spectroscopy, Applied Surface Science, 254 (2008) 6972-6975.
[54] A. Indra, P. W. Menezes, N. R. Sahraie, A. Bergmann, C. Das, M. Tallarida, D. Schmeißer, P. Strasser, M. Driess, Unification of catalytic water oxidation and oxygen reduction reactions: amorphous beat crystalline cobalt iron oxides, Journal of the American Chemical Society, 136 (2014) 17530-17536.
[55] Hou et al., Structural, electronic and magnetic properties of manganese substituted CoFe₂O₄: A first-principles study, Volume 495, 1 Feb. 2020, 165862, https://doi.org/10.1016/j.jmmm.2019.165862
[56] Chakrapani et al., The Role of Composition of Uniform and Highly Dispersed Cobalt Vanadium Iron Spinel Nanocrystals for Oxygen Electrocatalysis, ACS Catal. 2018, 8, 2, 1259-1267, https://doi.org/10.1021/acscatal.7b03529
[57] Chakrapani et al., Role of Composition and Size of Cobalt Ferrite Nanocrystals in the Oxygen Evolution Reaction, ChemCatChem, Volume 9, Issue 15, Aug. 9, 2017, Pages 2988-2995.
[58] Indra et al., Unification of Catalytic Water Oxidation and Oxygen Reduction Reactions: Amorphous Beat Crystalline Cobalt Iron Oxides, J. Am. Chem. Soc. 2014, 136, 50, 17530-17536.
[59] Xu et al., Preparation and electrocatalytic activity of 3D hierarchical porous spinel CoFe₂O₄ hollow nanospheres as efficient catalyst for Oxygen Reduction Reaction and Oxygen Evolution Reaction, Electrochimica Acta, Volume 151, 1 Jan. 2015, Pages 276-283
[60] Li et al., Facile synthesis of electrospun MFe2O4 (M=Co, Ni, Cu, Mn) spinel nanofibers with excellent electrocatalytic properties for oxygen evolution and hydrogen peroxide reduction, Nanoscale, 2015, 7, 8920-8930
[61] Yan et al., One-pot synthesis of monodispersed porous CoFe₂O₄ nanospheres on graphene as an efficient electrocatalyst for oxygen reduction and evolution reactions, RSC Adv., 2016, 6, 307-313.
[62] Zhou et al., Spinel Manganese Ferrites for Oxygen Electrocatalysis: Effect of Mn Valency and Occupation Site, Electrocatalysis volume 9, pages 287-292 (2018).
[63] Sun, Y., Liao, H., Wang, J. et al. Covalency competition dominates the water oxidation structure-activity relationship on spinel oxides. Nat Catal 3, 554-563 (2020). https://doi.org/10.1038/s41929-020-0465-6
[64] Görlin et al., Tracking Catalyst Redox States and Reaction Dynamics in Ni—Fe Oxyhydroxide Oxygen Evolution Reaction Electrocatalysts: The Role of Catalyst Support and Electrolyte pH, J. Am. Chem. Soc. 2017, 139, 5, 2070-2082
U.S. Pat. No. 10,246,768
US 2011/303869
US 2010/135450
WO 2018/009930
Zhou et al., Significance of Engineering the Octahedral Units to Promote the Oxygen Evolution Reaction of Spinel Oxides, Adv. Mater. 2019, 31, 1902509.
Mitra et al., An Efficient and Robust Surface-Modified Iron Electrode for Oxygen Evolution in Alkaline Water Electrolysis, Journal of The Electrochemical Society, 165 (5) F392-F400 (2018)
Görlin et al., Tracking Catalyst Redox States and Reaction Dynamics in Ni—Fe Oxyhydroxide Oxygen Evolution Reaction Electrocatalysts: The Role of Catalyst Support and Electrolyte pH, J. Am. Chem. Soc. 2017, 139, 5, 2070-2082
Razmjooei, F., Liu, T., Azevedo, D. A. et al. Improving plasma sprayed Raney-type nickel-molybdenum electrodes towards high-performance hydrogen evolution in alkaline medium. Sci Rep 10, 10948 (2020). https://doi.org/10.1038/s41598-020-67954-y.
McCrory et al., Benchmarking Heterogeneous Electrocatalysts for the Oxygen Evolution Reaction, J. Am. Chem. Soc. 2013, 135, 45, 16977-16987, https://pubs.acs.org/doi/10.1021/ja407115p.
Chakrapani et al., The Role of Composition of Uniform and Highly Dispersed Cobalt Vanadium Iron Spinel Nanocrystals for Oxygen Electrocatalysis, ACS Catal. 2018, 8, 2, 1259-1267
Yujiao Xu, Weiyong Bian, Jiao Wu, Jing-Hua Tian, Ruizhi Yang, Preparation and electrocatalytic activity of 3D hierarchical porous spinel CoFe₂O₄ hollow nanospheres as efficient catalyst for Oxygen Reduction Reaction and Oxygen Evolution Reaction, Electrochimica Acta, Volume 151, 2015, Pages 276-283, ISSN 0013-4686, https://doi.org/10.1016/j.electacta.2014.11.042.
Li et al., Facile synthesis of electrospun MFe204 (M=Co, Ni, Cu, Mn) spinel nanofibers with excellent electrocatalytic properties for oxygen evolution and hydrogen peroxide reduction, Nanoscale, 2015, 7, 8920-8930
Yan et al., One-pot synthesis of monodispersed porous CoFe₂O₄ nanospheres on graphene as an efficient electrocatalyst for oxygen reduction and evolution reactions, RSC Adv., 2016, 6, 307-313
Zhou, Y., Du, Y., Xi, S. et al. Spinel Manganese Ferrites for Oxygen Electrocatalysis: Effect of Mn Valency and Occupation Site. Electrocatalysis 9, 287-292 (2018). https://doi.org/10.1007/s12678-017-0429-z
Geng et al., Precious-Metal-Free Co—Fe—O/rGO Synergetic Electrocatalysts for Oxygen Evolution Reaction by a Facile Hydrothermal Route, Volume 8, Issue 4, February 2015, Pages 659-664

1. Nanoparticles of a ferrite of formula MnₓCo_{y}Ni_{z}Fe_{3-(x+y+z)}O₄, wherein each of x, y and z is ≥0 and ≤1, and wherein 0<(x+y+z)<1.5,
wherein the ferrite has a spinel crystalline structure,
wherein the nanoparticles have a truncated octahedron shape exposing facets, wherein said facets comprise 6 square facets and 8 hexagonal facets, wherein the square facets correspond to the {100} crystal plane and the hexagonal facets correspond to the {111} crystal plane, and
wherein the nanoparticles are up to about 500 nm in size.

2. (canceled)

3. (canceled)

4. (canceled)

5. An electrode comprising the nanoparticles of claim 1.

6. An electrolytic cell comprising an electrode comprising the nanoparticles of claim 1 as an anode, a cathode as well as an electrolyte between the anode and the cathode.

7. (canceled)

8. (canceled)

9. The nanoparticles of claim 1, wherein the nanoparticles are at least about 90% crystalline.

10. The nanoparticles of claim 1, wherein the lattice parameter of the spinel crystalline structure is about 8.4 Å.

11. (canceled)

12. The nanoparticles of claim 1, wherein the facets exposed on the nanoparticles further comprises {110} facets intersecting the {111} plane.

13. The nanoparticles of claim 12, wherein the {110} facets make up at most about 5% of the surface area of the nanoparticles.

14. (canceled)

15. The nanoparticles of claim 1, wherein the nanoparticles are mostly free of {110} facets.

16. The nanoparticles of claim 1, wherein z is at most about 0.5.

17. The nanoparticles of claim 1, wherein y=1−x.

18. The nanoparticles of claim 1, wherein 0<x<1.

19. (canceled)

20. The nanoparticles of claim 1, wherein the ferrite is of formula MnₓCo₁₋ₓFe₂O₄, wherein 0≤x<1.

21. (canceled)

22. (canceled)

23. (canceled)

24. The nanoparticles of claim 1, wherein the nanoparticles/nanocrystals have a median side of about 20 nm to about 50 nm.

25. The nanoparticles of claim 1, wherein the nanoparticles/nanocrystals have a homogeneous elemental composition.

26. (canceled)

27. The nanoparticles of claim 1, wherein the nanoparticles/nanocrystals have an average BET surface of about 0.4 m² g⁻¹ to about 0.7 m² g⁻¹.

28. The nanoparticles of claim 1, wherein the nanoparticles/nanocrystals have an {100}/{111} area facet ratio of about 0.46 to about 0.64.

29. (canceled)

30. The nanoparticles of claim 29, comprising both Fe2+ and Fe3+ ions and having a Fe⁺³/ΣFe ratio from about 0.50 to about 0.70.

31. The nanoparticles of claim 1, wherein the nanoparticles are self-supporting.

32. The nanoparticles of claim 1, wherein the nanoparticles are free of capping agents.

33. The nanoparticles of claim 1, wherein the nanoparticles are free of surfactants.
